(19) United States
(12) Patent Application Publication
(10) Pub. No.: US 2015/0234548 A1
(43) Pub. Date: Aug. 20, 2015

(54) GRAPHICAL USER INTERFACE WITH UNFOLDING PANEL

(71) Applicant: Nagravision S.A., Cheseaux-sur-Lausanne (CH)

(72) Inventor: Ludovic Pierre, Paris (FR)

(73) Assignee: Nagravision S.A., Cheseaux-sur-Lausanne (CH)

(21) Appl. No.: 14/184,448

(22) Filed: Feb. 19, 2014

(51) Int. Cl. G06F 3/0482; G06T 13/20; G06F 3/0481

(52) U.S. Cl. CPC G06F 3/0482; G06F 3/04815; G06T 13/20

(57) ABSTRACT

As presented by a server machine or a device, a graphical user interface may include first and second panels presented on a display. The first panel may show a set of menu items that include a menu item that is highlighted by a shape that surrounds the menu item. The second panel may be presented adjacent to the first panel and may show a set of one or more sub-menu items that correspond to the highlighted menu item. In response to a selection of the highlighted menu item, the presenting of the graphical user interface may include presenting an animated transition that shows the first panel folding out of view underneath the second panel, the third panel unfolding into view from beneath the second panel, and the shape transitioning from surrounding the menu item in the first panel to surrounding a sub-menu item in the second panel.

### TECHNICAL FIELD

The subject matter disclosed herein generally relates to the processing of data. Specifically, the present disclosure addresses systems and methods to present a graphical user interface.

### BACKGROUND

A graphical user interface (GUI) may be presented (e.g., displayed) on a display (e.g., a screen). For example, a first device (e.g., a smart phone or tablet computer) may have a built-in display, and the first device may present a GUI on the built-in display. As another example, a second device (e.g., a set-top box, network-enabled consumer appliance, or personal computer) may be connected (e.g., wirelessly or by one or more cables) to an external display screen, and the second device may present a GUI on the external display. As a further example, a server (e.g., a video head-end server, a media server, or a website server) may provide information to one or more devices and accordingly cause the one or more devices to present a GUI on each of their respective displays (e.g., built-in or external).

### BRIEF DESCRIPTION OF THE DRAWINGS

Some embodiments are illustrated by way of example and not limitation in the figures of the accompanying drawings.

FIG. 1 is a network diagram illustrating a network environment suitable for presenting a GUI with an unfolding panel, according to some example embodiments.

FIG. 2 is a block diagram illustrating components of a server machine suitable for presenting a GUI with an unfolding panel, according to some example embodiments.

FIGS. 3 and 4 are block diagrams illustrating components of devices suitable for presenting a GUI with an unfolding panel, according to some example embodiments.

FIGS. 5-10 are face views of a display as it presents a GUI with an unfolding panel and a stationary highlight shape, according to some example embodiments.

FIGS. 11-16 are face views of the display as it presents a GUI with an unfolding panel and an elastic highlight shape, according to some example embodiments.

FIGS. 17-22 are face views of the display as it presents a GUI with an unfolding panel and a foldable highlight shape, according to some example embodiments.

FIGS. 23-27 are flowcharts illustrating operations in a method of presenting a GUI with an unfolding panel, according to some example embodiments.

FIG. 28 is a block diagram illustrating components of a machine, according to some example embodiments, able to read instructions from a machine-readable medium and perform any one or more of the methodologies discussed herein.

### DETAILED DESCRIPTION

Example methods and systems are directed to identification of one or more media sources. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

As presented by a server machine, a device with a built-in display, a device with an external display, or any suitable combination thereof, a GUI may include first and second panels (e.g., first and second polygonal graphical objects, such as rectangles) presented on a display at a first point in time. The first panel may show a set of menu items that include a highlighted menu item that is highlighted by a shape (e.g., a highlight shape) that surrounds it. The second panel may be presented adjacent to the first panel, and the second panel may show a set of one or more sub-menu items that correspond to the highlighted menu item in the first panel.

In response to a user's selection (e.g., by pressing a “select” button or “OK” button on a remote control device), the presenting of the GUI may include presenting an animated transition (e.g., a simulation or a simulated transition) that, after completion, omits the first panel, continues to present the second panel, and presents a third panel (e.g., third polygonal graphical object, such as a rectangle). In particular, the animated transition may include the first panel appearing to fold out of view behind (e.g., underneath) the second panel, the third panel appearing to fold into view from behind (e.g., from beneath) the second panel, the shape transitioning from surrounding the menu item in the first panel to surrounding a sub-menu item in the second panel, or any suitable combination thereof.

After the animated transition (e.g., simulation or simulated transition) is completed, the presenting of the GUI may present the second and third panels on the display at a second point in time. At this second point in time, the second panel may show the sub-menu item as being highlighted by the shape (e.g., the highlight shape). The third panel may show a set of one or more sub-sub-menu items that correspond to the highlighted sub-menu item in the second panel. Further details are discussed below.

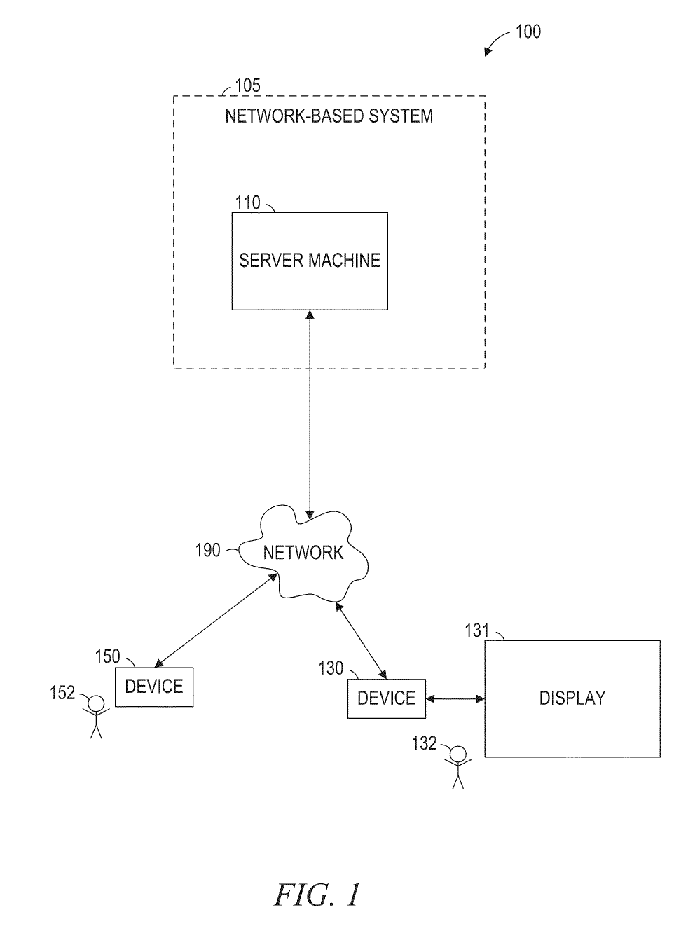

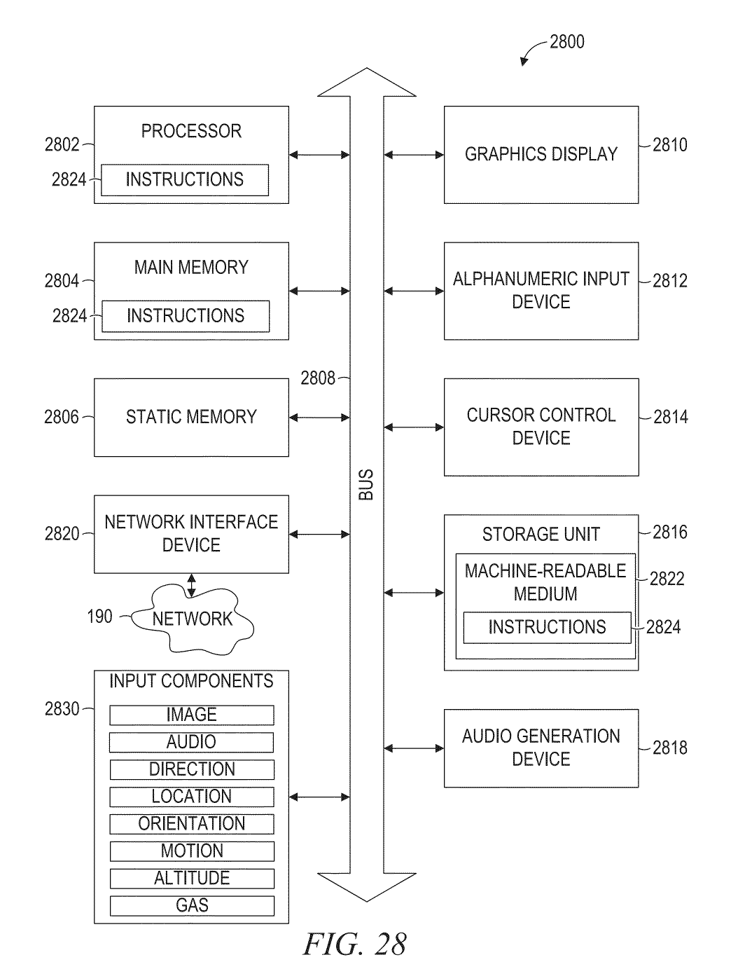

FIG. 1 is a network diagram illustrating a network environment 100 suitable for presenting a GUI with an unfolding panel, according to some example embodiments. The network environment 100 includes a server machine 110 and devices 130 and 150, all communicatively coupled to each other via a network 190. In some example embodiments, one or both of the devices 130 and 150 may be operated in a standalone mode (e.g., without network connectivity to the server machine 111 or any other machine or device). The server machine 110 and the devices 130 and 150 may each be implemented in a computer system, in whole or in part, as described below with respect to FIG. 28.

As shown, the device 130 may be communicatively coupled (e.g., connected wirelessly or by one or more cables) to a display 131 (e.g., an external display), while the device 150 may include a built-in display. Furthermore, the server machine 110 may form all or part of a network-based system 105. The server machine 110, the network-based system 105, or any suitable combination thereof, may be configured to provide one or more media services (e.g., provision, broadcast, or other communication of media content), one or more GUIs, or both, to various devices (e.g., devices 130 and 150).

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a set top box (e.g., integrated receiver-decoder), a home media player, a network-enabled consumer appliance (e.g., a smart refrigerator, or a smart coffee maker), a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be set top box, a home media player, a network-enabled consumer appliance, a desktop computer, a vehicle computer, a tablet computer, a navigational device, a portable media device, or a smart phone belonging to the user 152.

Any of the machines or devices shown in FIG. 1 may be implemented in a general-purpose computer modified (e.g., configured or programmed) by software to be a special-purpose computer to perform one or more of the functions described herein for that machine or device. For example, a computer system able to implement any one or more of the methodologies described herein is discussed below with respect to FIG. 28. Moreover, any two or more of the machines or devices illustrated in FIG. 1 may be combined into a single machine, and the functions described herein for any single machine or device may be subdivided among multiple machines or devices.

The network 190 may be any network that enables communication between or among machines and devices (e.g., the server machine 110 and the device 130). Accordingly, the network 190 may be a wired network (e.g., a fiber optic network, a cable television network, or an Ethernet network), a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), a cable television network, a satellite television network, or any suitable combination thereof. Any one or more portions of the network 190 may communicate information via a transmission medium. As used herein, “transmission medium” refers to any intangible medium that is capable of storing, encoding, or carrying instructions for execution by a machine, and includes digital or analog communication signals or other intangible media to facilitate communication of such software.

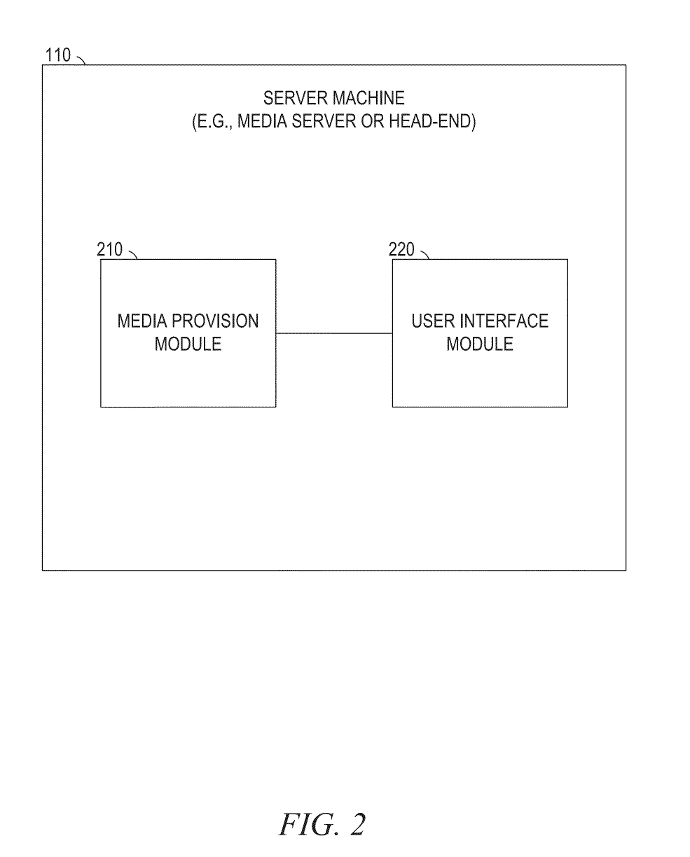

FIG. 2 is a block diagram illustrating components of the server machine 110, according to some example embodiments. As noted in FIG. 2, the server machine 110 may form all or part of a media server, a media head-end system, or any suitable combination thereof. The server machine 110 is shown as including the media provision module 210 and a user interface module 220, configured to communicate with each other (e.g., via a bus, shared memory, or a switch). Any one or more of the modules described herein may be implemented using hardware (e.g., a processor of a machine) or a combination of hardware and software. For example, any module described herein may be or include special-purpose software that configures one or more processors to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

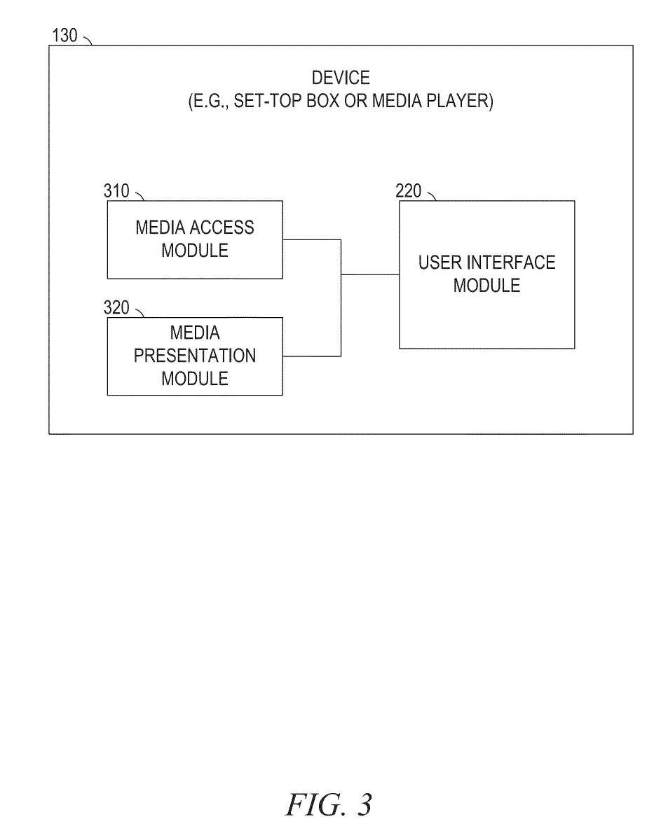

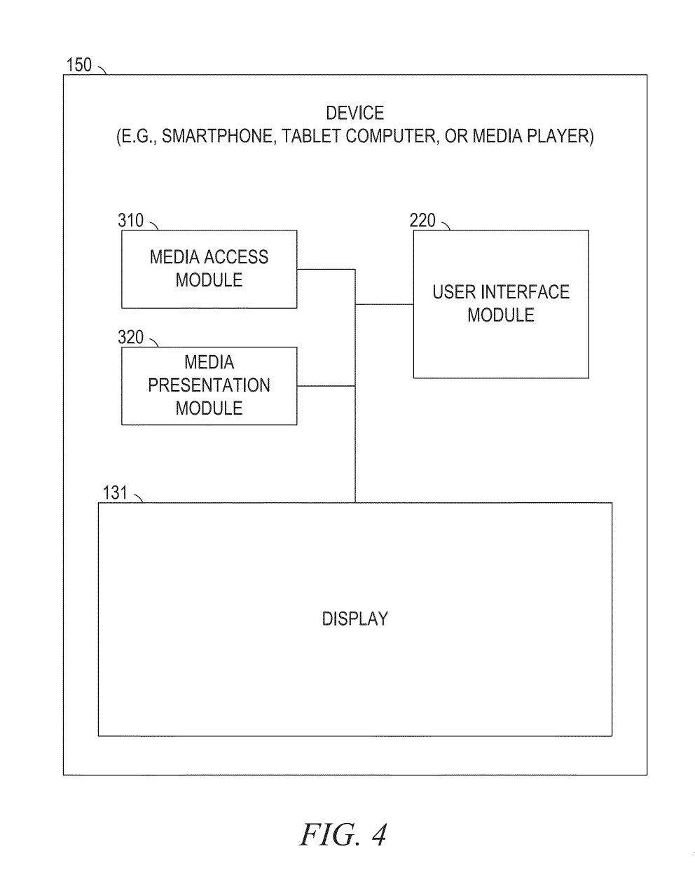

FIGS. 3 and 4 are block diagrams illustrating components of devices suitable for presenting a GUI with an unfolding panel, according to some example embodiments. As noted in FIG. 3, the device 130 may be or include a set top box, a media player (e.g., a home media player), or any suitable combination thereof. The device 130 is shown as including a media access module 310, a user interface module 220, and a media presentation module 320, all configured to communicate with each other (e.g., via a bus, shared memory, or a switch). As noted above, any one or more of these modules may be or include special-purpose software that configures one or more processors to perform the operations described herein for that module.

As noted in FIG. 4, the device 150 may be or include a smart phone, a tablet computer, a media player (e.g., a portable media player), or any suitable combination thereof. The device 150 is shown as including a media access module 310, a user interface module 220, a media presentation module 320, and a display 131, all configured to communicate with each other (e.g., via a bus, shared memory, or a switch). As noted above, any one or more of these modules may be or include special-purpose software that configures one or more processors to perform the operations described herein for that module.

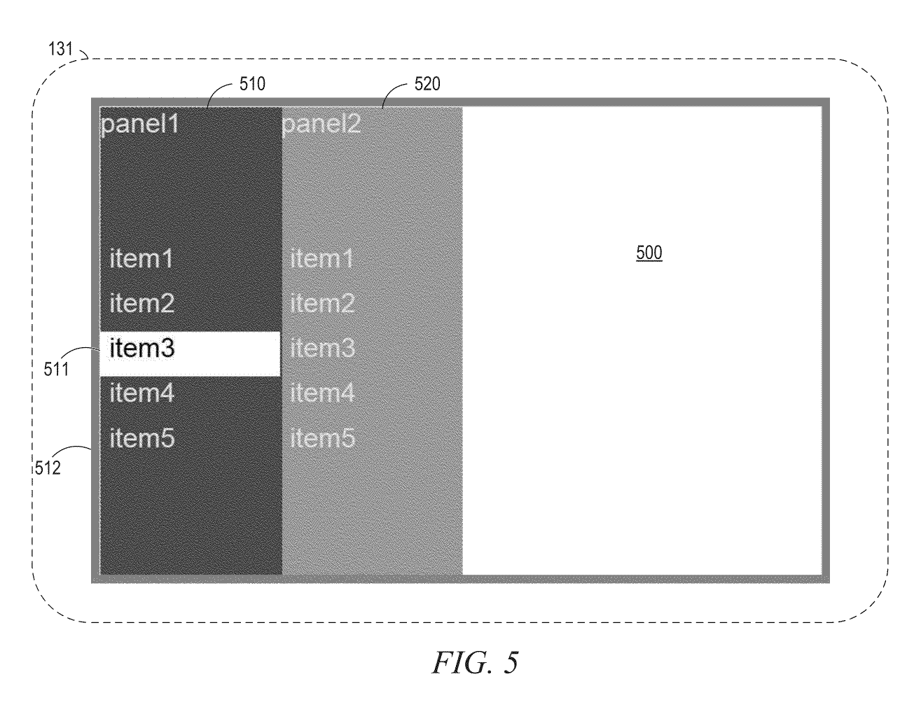

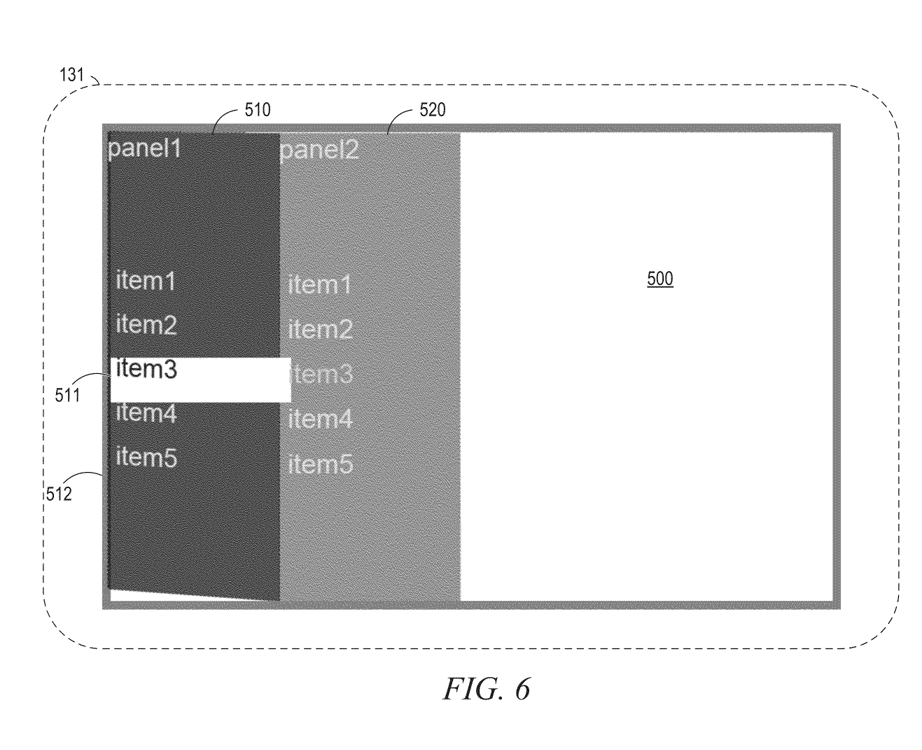

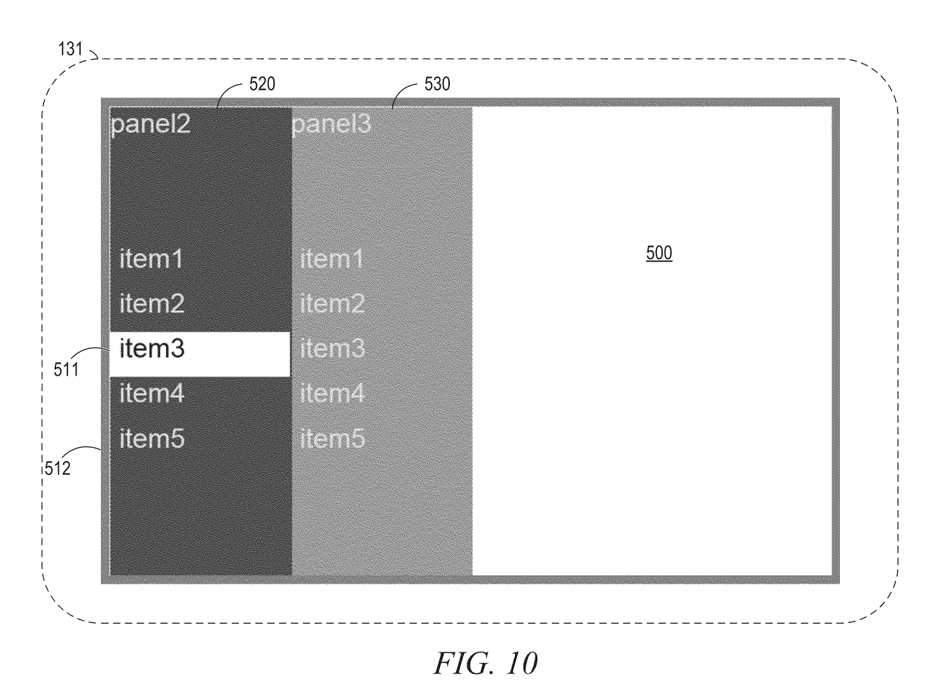

FIGS. 5-10 are face views of the display 131 as it presents a GUI, according to some example embodiments. Specifically, FIGS. 5-10 illustrate an animated transition that may begin (e.g., at a first time) with the appearance of the display 131 as shown in FIG. 5, progress through one or more of the appearances of the display 131 as shown in FIGS. 6-9, and end (e.g., at a second time) with the appearance of the display 131 as shown in FIG. 10. FIGS. 5-10 may thus illustrate all or part of a sequence of images shown on the display 131.

As shown in FIG. 5, at the beginning of the animated transition, a first panel 510 (e.g., labeled “panel1”) of the GUI may be presented adjacent to an edge 512 of the display 131. In some example embodiments, the first panel 510 has an edge (e.g., a left edge, a right edge, a top edge, or a bottom edge) that is equal in length to the adjacent edge 512 of the display 131 (e.g., a left edge, a right edge, a top edge, or bottom edge of a screen of the display 131). In alternative example embodiments, the first panel 510 has no edges that are equal in length to the adjacent edge 512 of the display 131.

As shown in FIG. 5, at the beginning of the animated transition, the first panel 510 may show a set of menu items (e.g., labeled “item1,” “item2,” “item3,” “item4,” and “item5”) that include a menu item (e.g., labeled “item3”) highlighted by a shape 511 that surrounds (e.g., envelops or encompasses) the menu item. According to some example embodiments, the shape 511 may be a stationary highlight shape (e.g., fixed in position with respect to the display 131) that is usable to highlight (e.g., by surrounding) a menu item, a sub-menu item, a sub-sub-menu item, or any suitable combination thereof.

As shown in FIG. 5, at the beginning of the animated transition, a second panel 520 (e.g., labeled “panel2”) of the GUI may be presented adjacent to the first panel 510 (e.g., having an edge shared in common with the first panel 510). Furthermore, the second panel 520 may show a set of sub-menu items (e.g., labeled “item1,” “item2,” “item3,” “item4,” and “item5”) that correspond to the highlighted menu item in the first panel 510. For example, the set of sub-menu items may be assigned or mapped to the highlighted menu item within a hierarchy of menu items, and such a hierarchy may be stored by the user interface module 220 or may be otherwise accessible by the user interface module 220 (e.g., from the server machine 110). Moreover, the set of sub-menu items may include a sub-menu item (e.g., labeled “item3”) that, in the second panel 520, is aligned with the highlighted menu item in the first panel 510 (e.g., vertically aligned, horizontally aligned, or both). Accordingly, the aligned sub-menu item may be in a position to become highlighted by the shape 511 after completion of the animated transition.

As shown in FIG. 5, at the beginning of the animated transition, the presented GUI may be superimposed over media content 500, which may be partially obscured by the first panel 510, the second panel 520, or both. FIG. 5 illustrates at least a portion of the media content 500 being unobscured and visible in the display 131. According to various example embodiments, all or part of the presented GUI may be translucent, opaque, or any suitable combination thereof. For example, the first panel 510 may be an opaque panel that fully obscures the portion of the media content 500 underneath the first panel 510. Alternatively, the first panel 510 may be a translucent panel that only partially obscures the portion of the media content 500 underneath the first panel 510. Similarly, the second panel 520 may be an opaque panel that fully obscures that portion of the media content 500 which lies underneath the second panel 520. Alternatively, the second panel 520 may be a translucent panel that only partially obscures that portion of the media content 500.

As shown in FIG. 6, as part of the animated transition, the first panel 510 has the appearance of beginning to fold out of view (e.g., underneath or behind the second panel 520). The appearance of this motion may be generated by the user interface module 220 (e.g., using three-dimensional graphics rendering software, three-dimensional graphics acceleration hardware, or both). Accordingly, the set of menu items shown in the first panel 510 may have the appearance of remaining in the same plane as the first panel 510 as it folds. Moreover, the common edge between the first panel 510 and the second panel 520 may move (e.g., leftwards) toward the edge 512 of the display 131. This may result in the entirety of the second panel 520 sliding (e.g., leftwards) toward the edge 512 of the display 131. Furthermore, the sliding of the second panel 520 may be specifically depicted as being exclusively within a two-dimensional plane of the display 131 (e.g., without a three-dimensional graphical effects), which may reflect a design philosophy that the attention of one or more viewers has moved from the first panel 510 to the second panel 520, and that such viewers may be annoyed by three-dimensional effects being applied to the second panel 520 (e.g., due to poor readability).

FIG. 6 illustrates the shape 511 as a stationary highlight shape (e.g., fixed in position with respect to the display 131). Hence, the shape 511 is shown remaining in the same position shown in FIG. 5 (e.g., with its horizontal edges and vertical edges not moving relative to the display 131) and consequently extending into the second panel 520 (e.g., as a result the second panel 520 moving toward the edge 512 of the display 131). In addition, this part of the animated transition may alter the portions of the media content 500 that are unobstructed by the presented GUI.

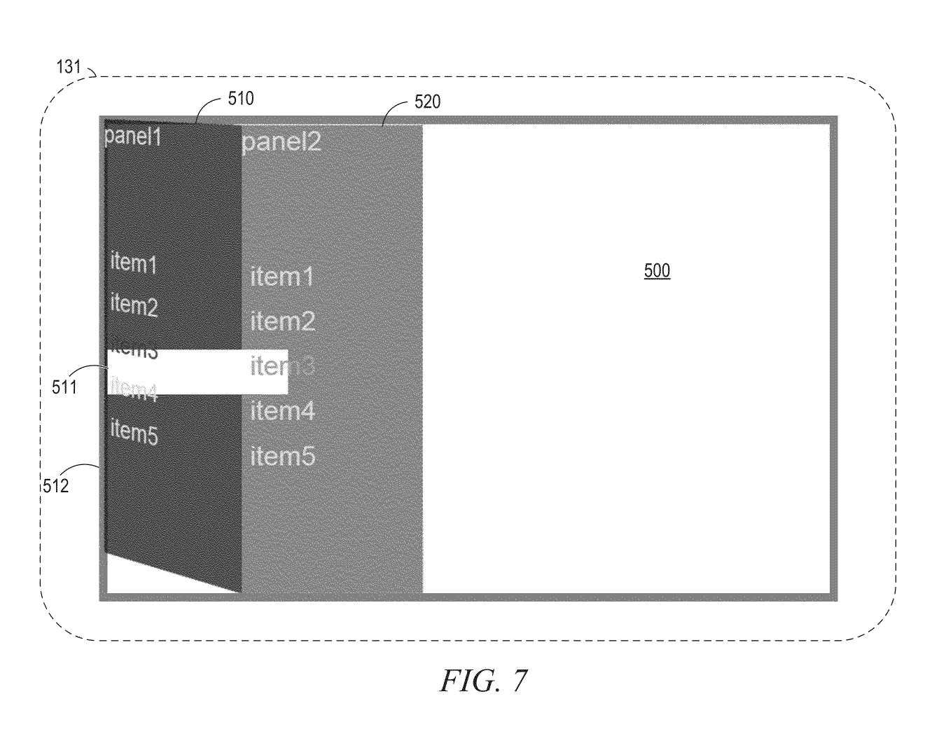

As shown in FIG. 7, as part of the animated transition, the first panel 510 has the appearance of continuing to fold out of view (e.g., underneath or behind the second panel 520). The appearance of this motion may be generated by the user interface module 220 (e.g., using three-dimensional graphics rendering software, three-dimensional graphics acceleration hardware, or both). Accordingly, the set of menu items shown in the first panel 510 may have the appearance of remaining in the same plane as the first panel 510 as it folds further. Moreover, the common edge between the first panel 510 and the second panel 520 may move further (e.g., leftwards) toward the edge 512 of the display 131. This may result in the entirety of the second panel 520 sliding further (e.g., leftwards) toward the edge 512 of the display 131.

FIG. 7 illustrates the shape 511 as a stationary highlight shape. Hence, the shape 511 is shown remaining in the same position shown in FIG. 6 and consequently extending further into the second panel 520. Furthermore, the sub-menu item (e.g., labeled “item3”) that was aligned in FIG. 5 with the highlighted menu item in the first panel 510 is illustrated as starting to move into a position for being surrounded by the shape 511. In addition, this part of the animated transition may further alter the portions of the media content 500 that are unobstructed by the presented GUI.

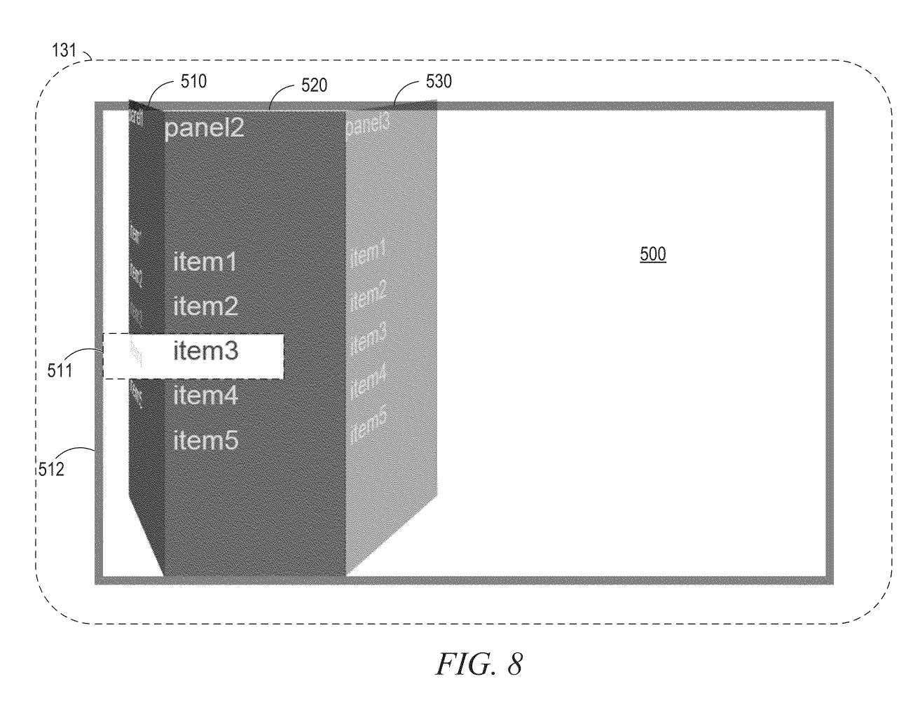

As shown in FIG. 8, as part of the animated transition, the first panel 510 has the appearance of continuing to fold further out of view (e.g., underneath or behind the second panel 520), while a third panel 530 (e.g., labeled “panel3”) has the appearance of beginning to unfold into view (e.g., from underneath or behind the second panel 520). The appearance of these motions may be generated by the user interface module 220 (e.g., using three-dimensional graphics rendering software, three-dimensional graphics acceleration hardware, or both). Accordingly, the set of menu items shown in the first panel 510 may have the appearance of remaining in the same plane as the first panel 510 as it folds further. Similarly, a set of sub-sub-menu items (e.g., labeled “item1,” “item2,” “item3,” “item4,” and “item5”) shown in the third panel 530 may have the appearance of remaining in the same plane as the third panel 530 as it unfolds. Moreover, the common edge between the first panel 510 and the second panel 520 may move further (e.g., leftwards) toward the edge 512 of the display 131. This may result in the entirety of the second panel 520 sliding further (e.g., leftwards) toward the edge 512 of the display 131.

FIG. 8 illustrates the shape 511 as a stationary highlight shape. Hence, the shape 511 is shown remaining in the same position shown in FIG. 7 and consequently extending further into the second panel 520. Furthermore, the sub-menu item (e.g., labeled “item3”) that was aligned in FIG. 5 with the highlighted menu item in the first panel 510 is illustrated as continuing to move into a position for being surrounded by the shape 511. Moreover, the sub-menu item may be shown in a color (e.g., black) that is readable when contrasted with a color of the shape 511 (e.g., white). In some example embodiments, the color of the sub-menu item may be changed (e.g., from white to black, or from gray to black) in response to the sub-menu item moving to position for being surrounded by the shape 511. In addition, this part of the animated transition may further alter the portions of the media content 500 that are unobstructed by the presented GUI.

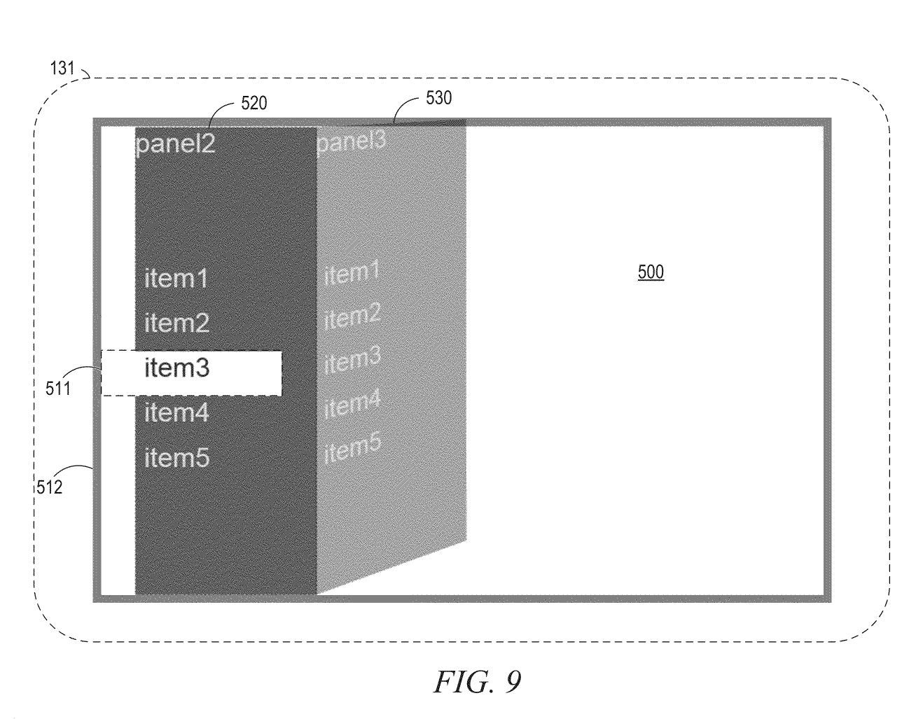

As shown in FIG. 9, as part of the animated transition, the first panel 510 has the appearance of being folded out of view (e.g., underneath or behind the second panel 520), while the third panel 530 has the appearance of continuing to unfold into view (e.g., from underneath or behind the second panel 520). The appearance of these motions may be generated by the user interface module 220 (e.g., using three-dimensional graphics rendering software, three-dimensional graphics acceleration hardware, or both). Accordingly, the set of sub-sub-menu items shown in the third panel 530 may have the appearance of remaining in the same plane as the third panel 530 as it unfolds. Moreover, the edge of the second panel 520 nearest the edge 512 of the display 131 may move further (e.g., leftwards) toward the edge 512 of the display 131. This may result in the entirety of the second panel 520 sliding further (e.g., leftwards) toward the edge 512 of the display 131.

FIG. 9 illustrates the shape 511 as a stationary highlight shape. Hence, the shape 511 is shown remaining in the same position shown in FIG. 8 and consequently extending even further into the second panel 520. Furthermore, the sub-menu item (e.g., labeled “item3”) that was aligned in FIG. 5 with the highlighted menu item in the first panel 510 is illustrated as continuing to move into a position for being surrounded by the shape 511. In addition, this part of the animated transition may further alter the portions of the media content 500 that are unobstructed by the presented GUI.

As shown in FIG. 10, at the end (e.g., completion) of the animated transition, the first panel 510 has the appearance of being fully folded out of view (e.g., underneath or behind the second panel 520), while the third panel 530 has the appearance of being fully unfolded into view (e.g., from underneath or behind the second panel 520). The appearance of the motions to reach this state may be generated by the user interface module 220 (e.g., using three-dimensional graphics rendering software, three-dimensional graphics acceleration hardware, or both). Accordingly, the set of sub-sub-menu items shown in the third panel 530 may have the appearance of remaining in the same plane as the third panel 530. Moreover, the edge of the second panel 520 nearest the edge 512 of the display 131 may be adjacent to the edge 512 of the display 131. This may result in the second panel 520 occupying the same space and position on the display 131 as was occupied by the first panel 510 at the beginning of the animated transition (e.g., as shown in FIG. 5).

FIG. 10 illustrates the shape 511 as a stationary highlight shape. Hence, the shape 511 is shown remaining in the same position shown in FIG. 9 and extended fully into the second panel 520. Furthermore, the sub-menu item (e.g., labeled “item3”) that was aligned in FIG. 5 with the highlighted menu item in the first panel 510 is illustrated as being surrounded by the shape 511. In addition, completion of the animated transition may restore the portions of the media content 500 that are unobstructed by the presented GUI to those portions that were unobscured at the beginning of the animated transition (e.g., as shown in FIG. 5).

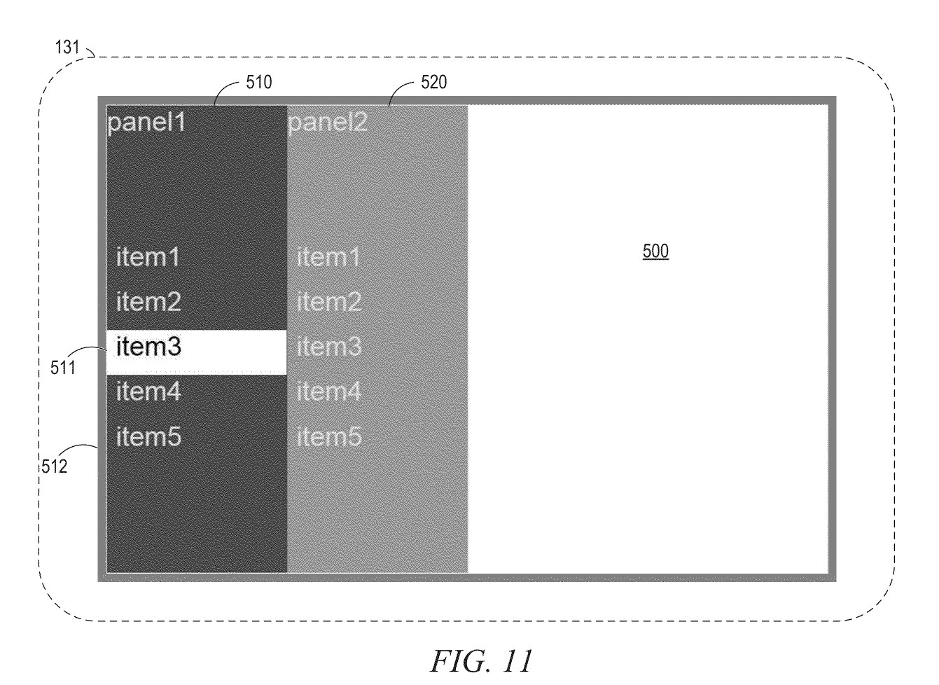

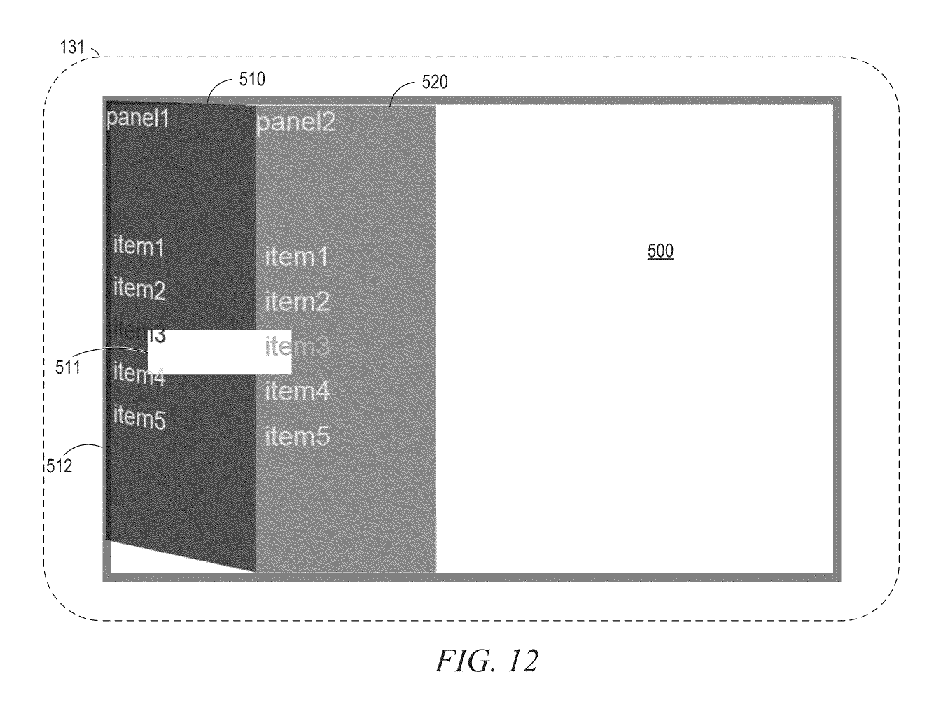

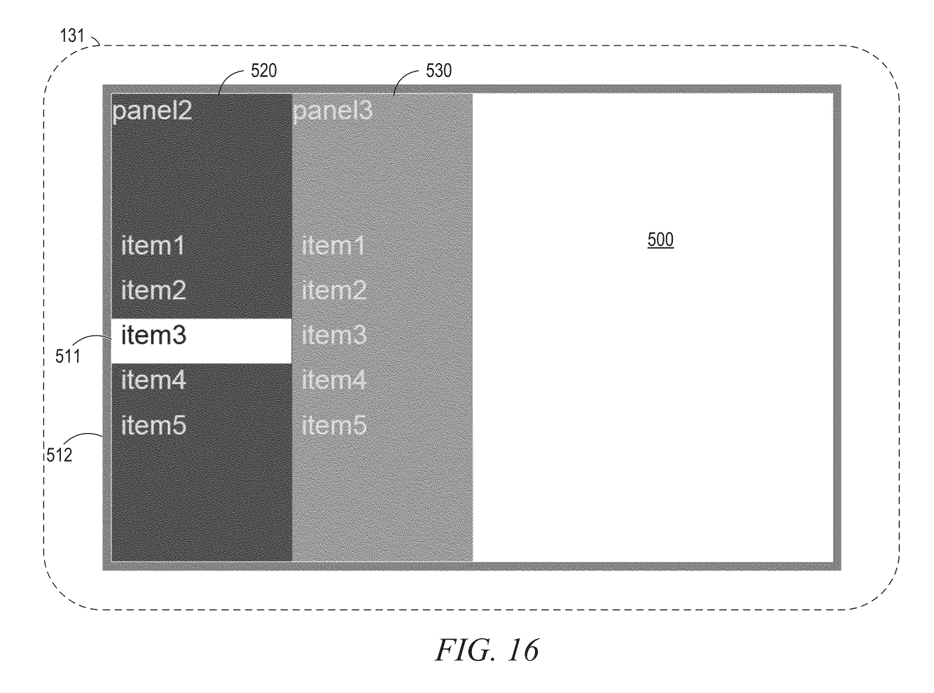

FIGS. 11-16 are face views of the display 131 as it presents a GUI, according to some example embodiments. Specifically, FIGS. 11-16 illustrate an animated transition that may begin (e.g., at a first time) with the appearance of the display 131 as shown in FIG. 11, progress through one or more of the appearances of the display 131 as shown in FIGS. 12-15, and end (e.g., at a second time) with the appearance of the display 131 as shown in FIG. 16. FIGS. 11-16 may thus illustrate all or part of a sequence of images shown on the display 131.

As shown in FIG. 11, at the beginning of the animated transition, the first panel 510 (e.g., labeled “panel1”) of the GUI may be presented adjacent to an edge 512 of the display 131. According to various example embodiments, the first panel 510 may have any one or more of the characteristics described above with respect to FIG. 5.

As shown in FIG. 11, at the beginning of the animated transition, the first panel 510 may show a set of menu items (e.g., labeled “item1,” “item2,” “item3,” “item4,” and “item5”) that include a menu item (e.g., labeled “item3”) highlighted by a shape 511 that surrounds (e.g., envelops or encompasses) the menu item. According to some example embodiments, the shape 511 may be an elastic highlight shape (e.g., not fixed in position with respect to the display 131) that is usable to highlight (e.g., by surrounding) a menu item, a sub-menu item, a sub-sub-menu item, or any suitable combination thereof.

As shown in FIG. 11, at the beginning of the animated transition, the second panel 520 (e.g., labeled “panel2”) of the GUI may be presented adjacent to the first panel 510 (e.g., having an edge shared in common with the first panel 510). According to various example embodiments, the second panel 520 may have any one or more of the characteristics described above with respect to FIG. 5. Furthermore, the second panel 520 may show a set of sub-menu items (e.g., labeled “item1,” “item2,” “item3,” “item4,” and “item5”) that correspond to the highlighted menu item in the first panel 510. Moreover, the set of sub-menu items may include a sub-menu item (e.g., labeled “item3”) that, in the second panel 520, is aligned with the highlighted menu item in the first panel 510 (e.g., vertically aligned, horizontally aligned, or both). Accordingly, the aligned sub-menu item may be in a position to become highlighted by the shape 511 after completion of the animated transition.

As shown in FIG. 11, at the beginning of the animated transition, the presented GUI may be superimposed over the media content 500, which may be partially obscured by the first panel 510, the second panel 520, or both. According to various example embodiments, all or part of the GUI may fully or partially obscure one or more portions of the media content 500, as discussed above with respect to FIGS. 5-10.

As shown in FIG. 12, as part of the animated transition, the first panel 510 has the appearance of beginning to fold out of view (e.g., underneath or behind the second panel 520). The appearance of this motion may be generated by the user interface module 220 (e.g., as noted above with respect to FIG. 6), and the set of menu items shown in the first panel 510 may have the appearance of remaining in the same plane as the first panel 510 as it folds. Moreover, the common edge between the first panel 510 and the second panel 520 may move (e.g., leftwards) toward the edge 512 of the display 131. This may cause the entirety of the second panel 520 to move (e.g., leftwards) toward the edge 512 of the display 131. Furthermore, this movement of the second panel 520 may be specifically depicted as being exclusively confined to a two-dimensional plane of the display 131 (e.g., without a three-dimensional graphical effects), which may reflect a design philosophy that the attention of one or more viewers has moved from the first panel 510 to the second panel 520, and that such viewers may be annoyed by three-dimensional effects being applied to the second panel 520 (e.g., due to poor readability).

FIG. 12 illustrates the shape 511 as an elastic highlight shape (e.g., not fixed in position with respect to the display 131). Hence, the shape 511 is shown with its horizontal edges (e.g., top and bottom edges, which may be parallel to the highlighted menu item throughout the animated transition) remaining unmoved relative to the display 131 during this part of the animated transition and its first vertical edge (e.g., right edge) also remaining unmoved during this part of the animated transition, while its second vertical edge (e.g., a left edge) moves away from the edge 512 of the display 131 (e.g., toward the third panel 530 being unfolded into view during the animated transition). This behavior contrasts with the animated transition shown in FIGS. 5-10, during which the second vertical edge (e.g., the left edge) remains unmoved relative to the display 131. However, since the first vertical edge (e.g., the right edge) remains unmoved during this part of the animated transition, the shape 511 may consequently extend into the second panel 520 (e.g., as a result the second panel 520 moving toward the edge 512 of the display 131). In addition, this part of the animated transition may alter the portions of the media content 500 that are unobstructed by the presented GUI.

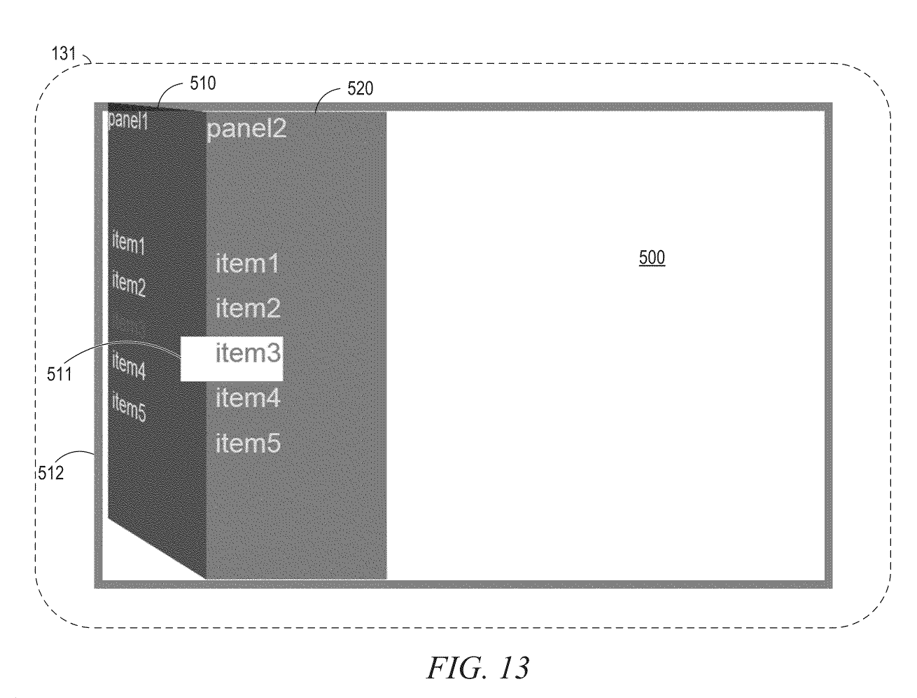

As shown in FIG. 13, as part of the animated transition, the first panel 510 has the appearance of continuing to fold out of view (e.g., underneath or behind the second panel 520). The appearance of this motion may be generated by the user interface module 220 (e.g., as noted above with respect to FIG. 7), and the set of menu items shown in the first panel 510 may have the appearance of remaining in the same plane as the first panel 510 as it folds further. Moreover, the common edge between the first panel 510 and the second panel 520 may move further (e.g., leftwards) toward the edge 512 of the display 131. This may cause the entirety of the second panel 520 to move further (e.g., leftwards) toward the edge 512 of the display 131.

FIG. 13 illustrates the shape 511 as an elastic highlight shape. Hence, the shape 511 is shown with its horizontal edges (e.g., top and bottom edges) remaining unmoved relative to the display 131 during this part of the animated transition and its first vertical edge (e.g., right edge) also remaining unmoved during this part of the animated transition, while its second vertical edge (e.g., left edge) moves further away from the edge 512 of the display 131 (e.g., toward the third panel 530 being unfolded into view during the animated transition). Since the first vertical edge (e.g., right edge) remains unmoved during this part of the animated transition, the shape 511 may consequently extend further into the second panel 520 (e.g., as a result of the second panel 520 moving toward the edge 512 of the display 131). In addition, this part of the animated transition may further alter the portions of the media content 500 that are unobstructed by the presented GUI.

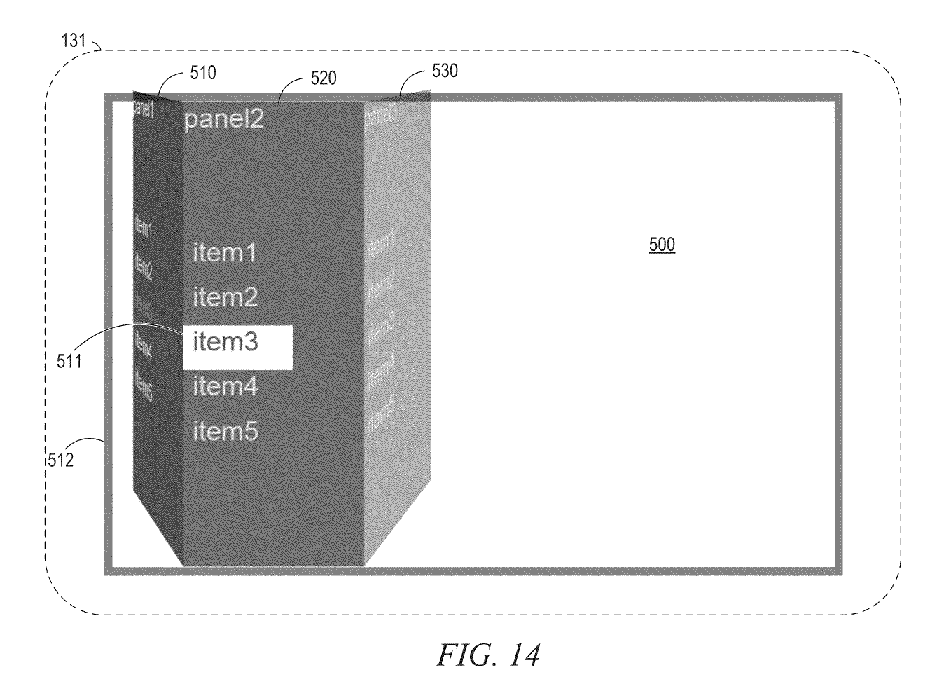

As shown in FIG. 14, as part of the animated transition, the first panel 510 has the appearance of continuing to fold further out of view (e.g., underneath or behind the second panel 520), while the third panel 530 (e.g., labeled “panel3”) has the appearance of beginning to unfold into view (e.g., from underneath or behind the second panel 520). The appearance of these motions may be generated by the user interface module 220 (e.g., as noted above with respect to FIG. 8), and the set of menu items shown in the first panel 510 may have the appearance of remaining in the same plane as the first panel 510 as it folds further. Similarly, a set of sub-sub-menu items (e.g., labeled “item1,” “item2,” “item3,” “item4,” and “item5”) shown in the third panel 530 may have the appearance of remaining in the same plane as the third panel 530 as it unfolds. Moreover, the common edge between the first panel 510 and the second panel 520 may move further (e.g., leftwards) toward the edge 512 of the display 131. This may cause the entirety of the second panel 520 to move further (e.g., leftwards) toward the edge 512 of the display 131.

FIG. 14 illustrates the shape 511 as an elastic highlight shape. Hence, the shape 511 is shown with its horizontal and vertical edges (e.g., top and bottom edges) remaining unmoved relative to the display 131 during this part of the animated transition and a first vertical edge (e.g., right edge) also remaining unmoved during this part of the animated transition, while a second vertical edge (e.g., left edge) moves further away from the edge 512 of the display 131 (e.g., toward the third panel 530 being unfolded into view during the animated transition). In some example embodiments, the second vertical edge (e.g., left edge) moves to meet the common edge between the first panel 510 and the second panel 520 and thereafter remains coincident with the common edge (e.g., affixed to the common edge as it moves toward the edge 512 of the display 131). Since the first vertical edge (e.g., right edge) remains unmoved during this part of the animated transition, the shape 511 may consequently extend further into the second panel 520 (e.g., as a result of the second panel 520 moving toward the edge 512 of the display 131). Moreover, a sub-menu item to be surrounded by the shape 511 may be shown in a color (e.g., black) that is readable when contrasted with a color of the shape 511 (e.g., white). In some example embodiments, the color of the sub-menu item may be changed (e.g., from white to black, or from gray to black) in response to the sub-menu item moving to position for being surrounded by the shape 511. In addition, this part of the animated transition may further alter the portions of the media content 500 that are unobstructed by the presented GUI.

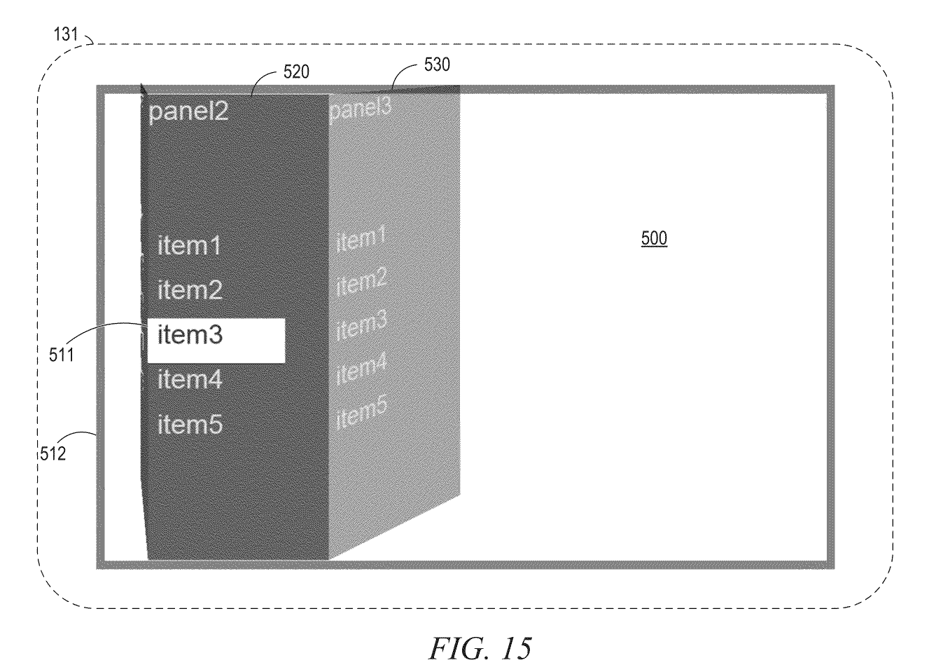

As shown in FIG. 15, as part of the animated transition, the first panel 510 has the appearance of being almost fully folded out of view (e.g., underneath or behind the second panel 520), while the third panel 530 has the appearance of continuing to unfold into view (e.g., from underneath or behind the second panel 520). The appearance of these motions may be generated by the user interface module 220 (e.g., as noted above with respect to FIG. 9). Accordingly, the set of sub-sub-menu items shown in the third panel 530 may have the appearance of remaining in the same plane as the third panel 530 as it unfolds. Moreover, the edge of the second panel 520 nearest the edge 512 of the display 131 may move further (e.g., leftwards) toward the edge 512 of the display 131. This may cause the entirety of the second panel 520 to move further (e.g., leftwards) toward the edge 512 of the display 131.

FIG. 15 illustrates the shape 511 as an elastic highlight shape. Hence, the shape 511 is shown with its horizontal and vertical edges (e.g., top and bottom edges) remaining unmoved relative to the display 131 during this part of the animated transition and its first vertical edge (e.g., right edge) also remaining unmoved during this part of the animated transition, while its second vertical edge (e.g., left edge) is coincident with (e.g., affixed to) the common edge between the first panel 510 and the second panel 520. The second vertical edge may thus move with the common edge between the first panel 510 and the second panel 520, as the common edge moves toward the edge 512 of the display 131. Since the first vertical edge (e.g., right edge) remains unmoved during this part of the animated transition, the shape 511 may consequently extend further into the second panel 520 (e.g., as a result of the second panel 520 moving toward the edge 512 of the display 131). In addition, this part of the animated transition may further alter the portions of the media content 500 that are unobstructed by the presented GUI.

As shown in FIG. 16, at the end (e.g., completion) of the animated transition, the first panel 510 has the appearance of being fully folded out of view (e.g., underneath or behind the second panel 520), while the third panel 530 has the appearance of being fully unfolded into view (e.g., from underneath or behind the second panel 520). The appearance of the motions to reach this state may be generated by the user interface module 220 (e.g., as noted above with respect to FIG. 10). Accordingly, the set of sub-sub-menu items shown in the third panel 530 may have the appearance of remaining in the same plane as the third panel 530. Moreover, the edge of the second panel 520 nearest the edge 512 of the display 131 may be adjacent to the edge 512 of the display 131. This may result in the second panel 520 occupying the same space and position on the display 131 as was occupied by the first panel 510 at the beginning of the animated transition (e.g., as shown in FIG. 11).

FIG. 16 illustrates the shape 511 as an elastic highlight shape, though the shape 511 is shown with its horizontal and vertical edges (e.g., top and bottom edges) and its first vertical edge (e.g., right edge) remaining unmoved from their positions on the display 131 at the beginning of the animated transition (e.g., as shown in FIG. 11). Moreover, the second vertical edge (e.g., left edge) of the shape 511 is shown as being restored to its position on the display 131 at the beginning of the animated transition (e.g., as shown in FIG. 11). Furthermore, the sub-menu item (e.g., labeled “item3”) that was aligned in FIG. 11 with the highlighted menu item in the first panel 510 is illustrated as being surrounded by the shape 511. In addition, completion of the animated transition may restore the portions of the media content 500 that are unobstructed by the presented GUI to those portions that were unobscured at the beginning of the animated transition (e.g., as shown in FIG. 11).

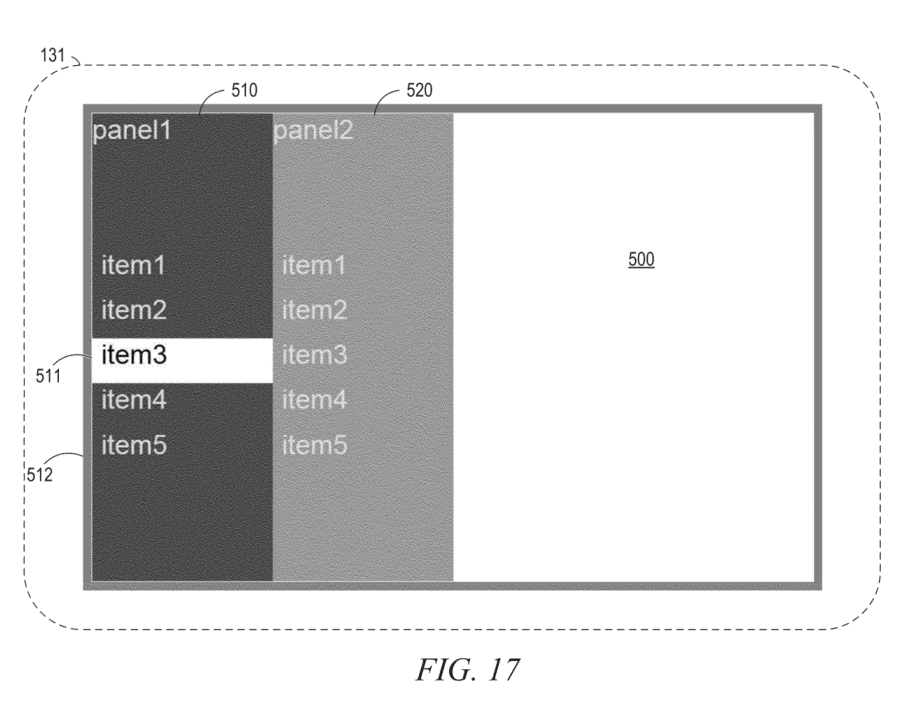

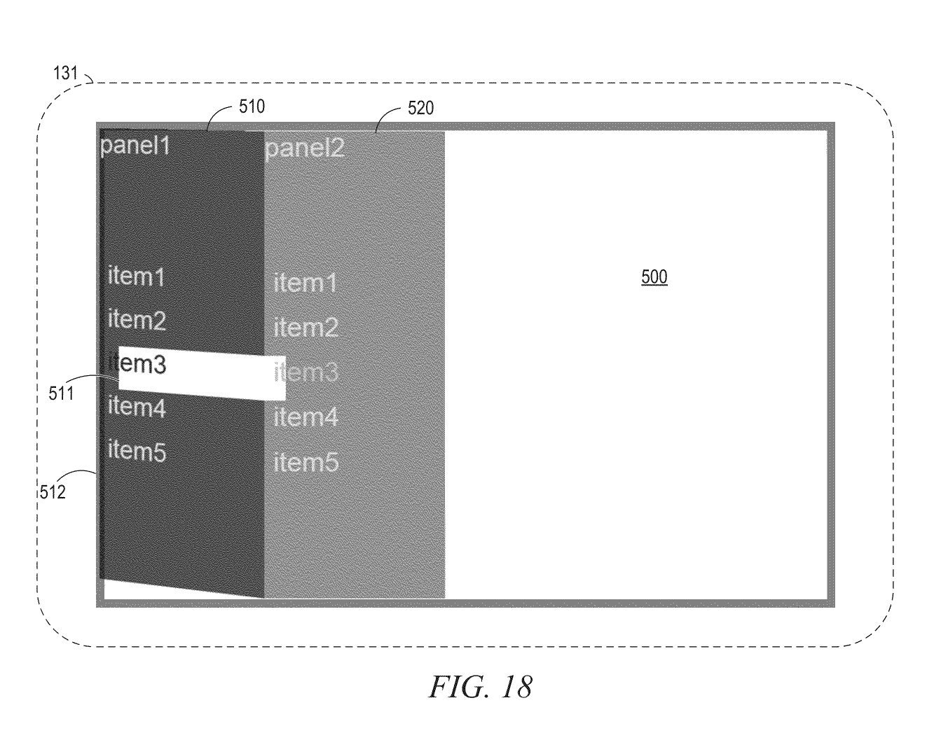

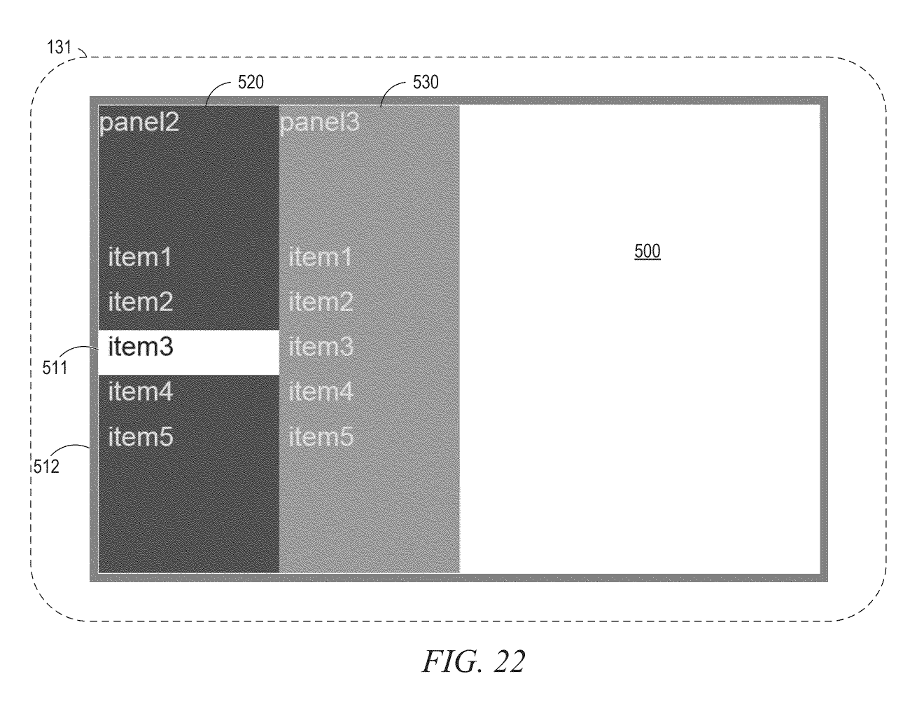

FIGS. 17-22 are face views of the display 131 as it presents a GUI, according to some example embodiments. Specifically, FIGS. 17-22 illustrate an animated transition that may begin (e.g., at a first time) with the appearance of the display 131 as shown in FIG. 17, progress through one or more of the appearances of the display 131 as shown in FIGS. 18-21, and end (e.g., at a second time) with the appearance of the display 131 as shown in FIG. 22. FIGS. 17-22 may thus illustrate all or part of a sequence of images shown on the display 131.

As shown in FIG. 17, at the beginning of the animated transition, the first panel 510 (e.g., labeled “panel1”) of the GUI may be presented adjacent to an edge 512 of the display 131. According to various example embodiments, the first panel 510 may have any one or more of the characteristics described above with respect to FIG. 5.

As shown in FIG. 17, at the beginning of the animated transition, the first panel 510 may show a set of menu items (e.g., labeled “item1,” “item2,” “item3,” “item4,” and “item5”) that include a menu item (e.g., labeled “item3”) highlighted by a shape 511 that surrounds (e.g., envelops or encompasses) the menu item. According to some example embodiments, the shape 511 may be a foldable highlight shape (e.g., appearing to fold with the first panel 510 as the first panel 510 moves out of view) that is usable to highlight (e.g., by surrounding) a menu item, a sub-menu item, a sub-sub-menu item, or any suitable combination thereof.

As shown in FIG. 17, at the beginning of the animated transition, the second panel 520 (e.g., labeled “panel2”) of the GUI may be presented adjacent to the first panel 510 (e.g., having an edge shared in common with the first panel 510). According to various example embodiments, the second panel 520 may have any one or more of the characteristics described above with respect to FIG. 5. Furthermore, the second panel 520 may show a set of sub-menu items (e.g., labeled “item1,” “item2,” “item3,” “item4,” and “item5”) that correspond to the highlighted menu item in the first panel 510. Moreover, the set of sub-menu items may include a sub-menu item (e.g., labeled “item3”) that, in the second panel 520, is aligned with the highlighted menu item in the first panel 510 (e.g., vertically aligned, horizontally aligned, or both). Accordingly, the aligned sub-menu item may be in a position to become highlighted by the shape 511 after completion of the animated transition.

As shown in FIG. 17, at the beginning of the animated transition, the presented GUI may be superimposed over the media content 500, which may be partially obscured by the first panel 510, the second panel 520, or both. According to various example embodiments, all or part of the GUI may fully or partially obscure one or more portions of the media content 500, as discussed above with respect to FIGS. 5-10.

As shown in FIG. 18, as part of the animated transition, the first panel 510 has the appearance of beginning to fold out of view (e.g., underneath or behind the second panel 520). The appearance of this motion may be generated by the user interface module 220 (e.g., as noted above with respect to FIG. 6), and the set of menu items shown in the first panel 510 may have the appearance of remaining in the same plane as the first panel 510 as it folds. Moreover, the common edge between the first panel 510 and the second panel 520 may move (e.g., leftwards) toward the edge 512 of the display 131. This may cause the entirety of the second panel 520 to move (e.g., leftwards) toward the edge 512 of the display 131. Furthermore, this movement of the second panel 520 may be specifically depicted as being exclusively confined to a two-dimensional plane of the display 131 (e.g., without a three-dimensional graphical effects), which may reflect a design philosophy that the attention of one or more viewers has moved from the first panel 510 to the second panel 520, and that such viewers may be annoyed by three-dimensional effects being applied to the second panel 520 (e.g., due to poor readability).

FIG. 18 illustrates the shape 511 as a foldable highlight shape (e.g., appearing to fold with the first panel 510 as the first panel 510 moves out of view). Hence, the shape 511 is shown straddling the first panel 510 and the second panel 520, with a first portion (e.g., a left portion) of the shape 511 appearing to fold with the first panel 510 and with a second portion (e.g., a right portion) of the shape 511 appearing to remain in the same plane as the second panel 520. The appearance of this motion may be generated by the user interface module 220 (e.g., using three-dimensional graphics rendering software, three-dimensional graphics acceleration hardware, or both). In some example embodiments, the second portion (e.g., the right portion) of the shape 511 may be shown with its horizontal edges (e.g., top and bottom edges, which may be parallel to the highlighted menu item throughout the animated transition) remaining unmoved relative to the display 131 during this part of the animated transition and its vertical edge (e.g., right edge) also remaining unmoved during this part of the animated transition. This behavior of the shape 511 contrasts with the animated transitions shown in FIGS. 5-10 and FIGS. 11-16. However, since the vertical edge (e.g., the right edge) remains unmoved during this part of the animated transition, the shape 511 may nonetheless extend into the second panel 520 (e.g., as a result the second panel 520 moving toward the edge 512 of the display 131). In addition, this part of the animated transition may alter the portions of the media content 500 that are unobstructed by the presented GUI.

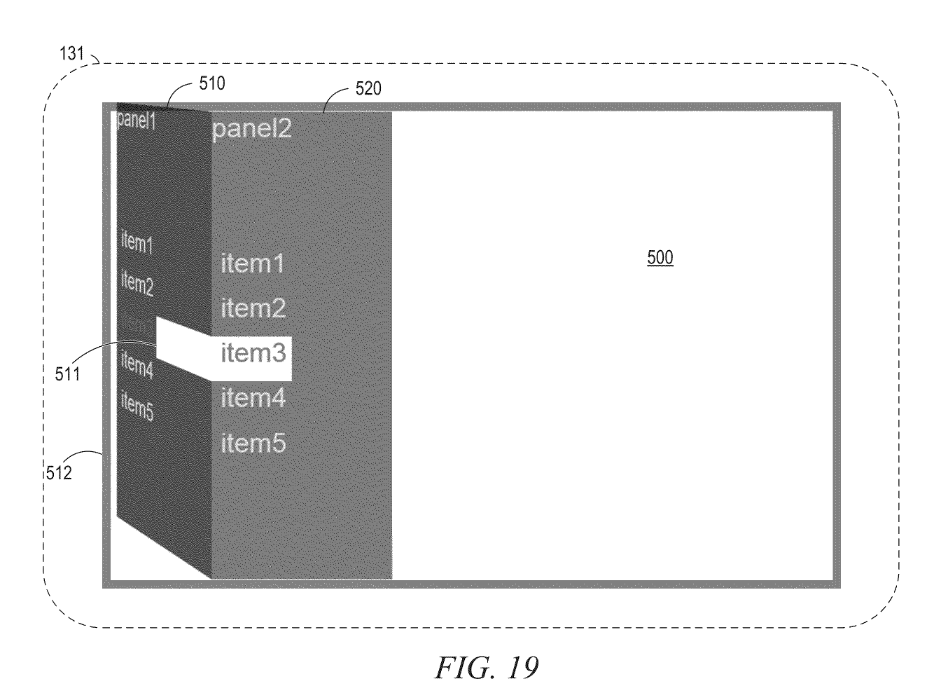

As shown in FIG. 19, as part of the animated transition, the first panel 510 has the appearance of continuing to fold out of view (e.g., underneath or behind the second panel 520). The appearance of this motion may be generated by the user interface module 220 (e.g., as noted above with respect to FIG. 7), and the set of menu items shown in the first panel 510 may have the appearance of remaining in the same plane as the first panel 510 as it folds further. Moreover, the common edge between the first panel 510 and the second panel 520 may move further (e.g., leftwards) toward the edge 512 of the display 131. This may cause the entirety of the second panel 520 to move further (e.g., leftwards) toward the edge 512 of the display 131.

FIG. 19 illustrates the shape 511 as a foldable highlight shape. Hence, the shape 511 is shown straddling the first panel 510 and the second panel 520, with a first portion (e.g., a left portion) of the shape 511 appearing to fold with the first panel 510 and with a second portion (e.g., a right portion) of the shape 511 appearing to remain in the same plane as the second panel 520. The appearance of this motion may be generated by the user interface module 220 (e.g., as noted above with respect to FIG. 18). In some example embodiments, the second portion (e.g., the right portion) of the shape 511 may be shown with its horizontal edges (e.g., top and bottom edges, which may be parallel to the highlighted menu item throughout the animated transition) remaining unmoved relative to the display 131 during this part of the animated transition and its vertical edge (e.g., right edge) also remaining unmoved during this part of the animated transition. However, since the vertical edge (e.g., the right edge) remains unmoved during this part of the animated transition, the shape 511 may extend into the second panel 520 (e.g., as a result the second panel 520 moving toward the edge 512 of the display 131). In addition, this part of the animated transition may alter the portions of the media content 500 that are unobstructed by the presented GUI.

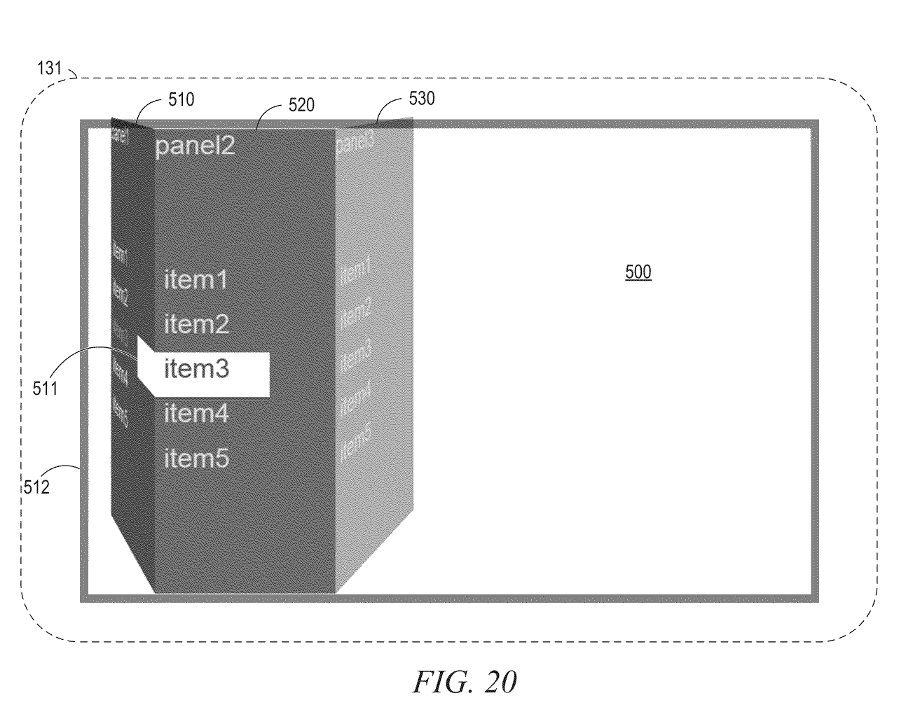

As shown in FIG. 20, as part of the animated transition, the first panel 510 has the appearance of continuing to fold further out of view (e.g., underneath or behind the second panel 520), while the third panel 530 (e.g., labeled “panel3”) has the appearance of beginning to unfold into view (e.g., from underneath or behind the second panel 520). The appearance of these motions may be generated by the user interface module 220 (e.g., as noted above with respect to FIG. 8), and the set of menu items shown in the first panel 510 may have the appearance of remaining in the same plane as the first panel 510 as it folds further. Similarly, a set of sub-sub-menu items (e.g., labeled “item1,” “item2,” “item3,” “item4,” and “item5”) shown in the third panel 530 may have the appearance of remaining in the same plane as the third panel 530 as it unfolds. Moreover, the common edge between the first panel 510 and the second panel 520 may move further (e.g., leftwards) toward the edge 512 of the display 131. This may cause the entirety of the second panel 520 to move further (e.g., leftwards) toward the edge 512 of the display 131.

FIG. 20 illustrates the shape 511 as a foldable highlight shape. Hence, the shape 511 is shown straddling the first panel 510 and the second panel 520, with a first portion (e.g., a left portion) of the shape 511 appearing to fold with the first panel 510 and with a second portion (e.g., a right portion) of the shape 511 appearing to remain in the same plane as the second panel 520. The appearance of this motion may be generated by the user interface module 220 (e.g., as noted above with respect to FIG. 18). For example, the shape 511 may be shown with a first vertical edge (e.g., right edge) also remaining unmoved during this part of the animated transition, while a second vertical edge (e.g., left edge) moves further away from the edge 512 of the display 131 (e.g., toward the third panel 530 being unfolded into view during the animated transition). In some example embodiments, the second vertical edge (e.g., left edge) moves to meet the common edge between the first panel 510 and the second panel 520 and thereafter remains coincident with the common edge (e.g., affixed to the common edge as it moves toward the edge 512 of the display 131). Since the first vertical edge (e.g., right edge) remains unmoved during this part of the animated transition, the shape 511 may extend further into the second panel 520 (e.g., as a result of the second panel 520 moving toward the edge 512 of the display 131). Moreover, a sub-menu item to be surrounded by the shape 511 may be shown in a color (e.g., black) that is readable when contrasted with a color of the shape 511 (e.g., white). In some example embodiments, the color of the sub-menu item may be changed (e.g., from white to black, or from gray to black) in response to the sub-menu item moving to position for being surrounded by the shape 511. In addition, this part of the animated transition may further alter the portions of the media content 500 that are unobstructed by the presented GUI.

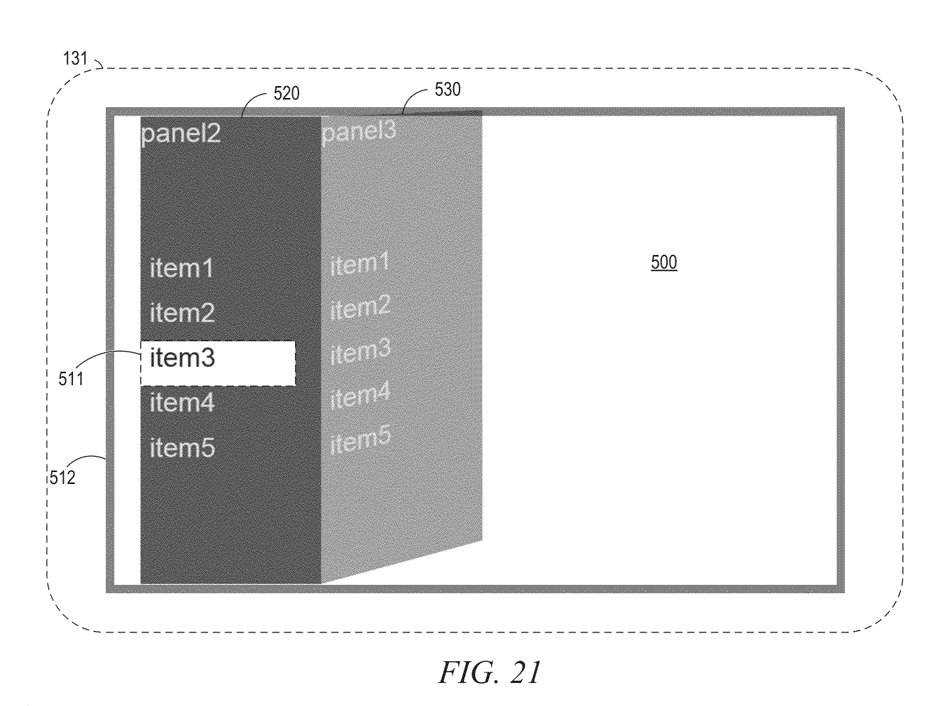

As shown in FIG. 21, as part of the animated transition, the first panel 510 has the appearance of being fully folded out of view (e.g., underneath or behind the second panel 520), while the third panel 530 has the appearance of continuing to unfold into view (e.g., from underneath or behind the second panel 520). The appearance of these motions may be generated by the user interface module 220 (e.g., as noted above with respect to FIG. 9). Accordingly, the set of sub-sub-menu items shown in the third panel 530 may have the appearance of remaining in the same plane as the third panel 530 as it unfolds. Moreover, the edge of the second panel 520 nearest the edge 512 of the display 131 may move further (e.g., leftwards) toward the edge 512 of the display 131. This may cause the entirety of the second panel 520 to move further (e.g., leftwards) toward the edge 512 of the display 131.

FIG. 21 illustrates the shape 511 as a foldable highlight shape. With the first panel 510 folded fully out of view, though, the shape 511 may be shown with its first vertical edge (e.g., remaining unmoved during this part of the animated transition, while its second vertical edge (e.g., left edge) remains coincident with (e.g., affixed to) the common edge between the first panel 510 and the second panel 520. The second vertical edge may thus move with the common edge between the first panel 510 and the second panel 520, as the common edge moves toward the edge 512 of the display 131. Since the first vertical edge (e.g., right edge) remains unmoved during this part of the animated transition, the shape 511 may consequently extend further into the second panel 520 (e.g., as a result of the second panel 520 moving toward the edge 512 of the display 131). In addition, this part of the animated transition may further alter the portions of the media content 500 that are unobstructed by the presented GUI.

As shown in FIG. 22, at the end (e.g., completion) of the animated transition, the first panel 510 has the appearance of being fully folded out of view (e.g., underneath or behind the second panel 520), while the third panel 530 has the appearance of being fully unfolded into view (e.g., from underneath or behind the second panel 520). The appearance of the motions to reach this state may be generated by the user interface module 220 (e.g., as noted above with respect to FIG. 10). Accordingly, the set of sub-sub-menu items shown in the third panel 530 may have the appearance of remaining in the same plane as the third panel 530. Moreover, the edge of the second panel 520 nearest the edge 512 of the display 131 may be adjacent to the edge 512 of the display 131. This may result in the second panel 520 occupying the same space and position on the display 131 as was occupied by the first panel 510 at the beginning of the animated transition (e.g., as shown in FIG. 17).

FIG. 22 illustrates the shape 511 as a foldable highlight shape, though the shape 511 is shown with its horizontal and vertical edges (e.g., top and bottom edges) and its first vertical edge (e.g., right edge) remaining unmoved from their positions on the display 131 at the beginning of the animated transition (e.g., as shown in FIG. 17). Moreover, the second vertical edge (e.g., left edge) of the shape 511 is shown as being restored to its position on the display 131 at the beginning of the animated transition (e.g., as shown in FIG. 17). Furthermore, the sub-menu item (e.g., labeled “item3”) that was aligned in FIG. 17 with the highlighted menu item in the first panel 510 is illustrated as being surrounded by the shape 511. In addition, completion of the animated transition may restore the portions of the media content 500 that are unobstructed by the presented GUI to those portions that were unobscured at the beginning of the animated transition (e.g., as shown in FIG. 17).

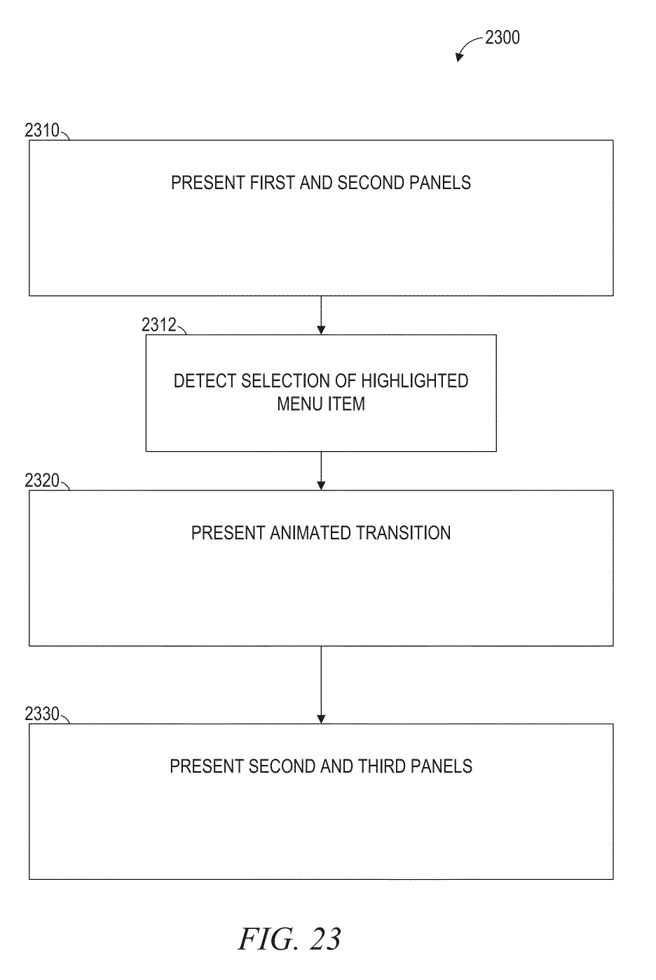

FIGS. 23-27 are flowcharts illustrating operations in a method 2300 of presenting a GUI with an unfolding panel (e.g., the third panel 530), according to some example embodiments. Operations in the method 2300 may be performed by the server machine 110 (e.g., using modules described above with respect to FIG. 2), by the device 130 (e.g., using modules described above with respect to FIG. 3), the device 150 (e.g., using modules described above with respect to FIG. 4), or by any suitable combination thereof. As shown in FIG. 23, the method includes operations 2310, 2320, and 2330, and may include operation 2312.

In operation 2310, the user interface module 220 presents the first panel 510 and the second panel 520 on the display 131. As noted above, the first panel 510 may show (e.g., by inclusion) a set of menu items, and this set of menu items may include a menu item that is highlighted by the shape 511. The shape 511 may surround the highlighted menu item. As also noted above, the second panel 520 may be adjacent to the first panel 510 and may show (e.g., by inclusion) a set of sub-menu items that correspond to the highlighted menu item in the first panel 510.

In operation 2312, the user interface module 220 detects a selection of the highlighted menu item. For example, the user interface module 220 may detect that the user 132 has selected the highlighted menu item (e.g., by pressing a “select” button or “OK” button on a remote control device communicatively coupled to the device 130 or communicatively coupled to the server machine 110).

In operation 2320, responsive to detecting that the highlighted menu item has been selected, the user interface module 220 presents (e.g., on the display 131) an animated transition (e.g., a simulation or a simulated transition) that, after completion, omits the first panel 510, continues to present the second panel 520, and presents the third panel 530. As discussed above with respect to FIGS. 5-22, the animated transition may include the first panel 510 appearing (e.g., as simulated) to fold out of view underneath or behind the second panel 520, the third panel 530 appearing (e.g., as simulated) to unfold into view from beneath or from behind the second panel 520, the shape 511 transitioning from surrounding the highlighted menu item in the first panel 510 to surrounding a sub-menu item (e.g., aligned horizontally or vertically with the highlighted menu item) in the second panel 520, or any suitable combination thereof.

In operation 2330, the user interface module 220 presents the second panel 520 and the third panel 530 on the display 131. As noted above, at the end (e.g., completion) of the animated transition, the second panel 520 may show the sub-menu item that had been previously aligned with the highlighted menu item now being highlighted by the shape 511.

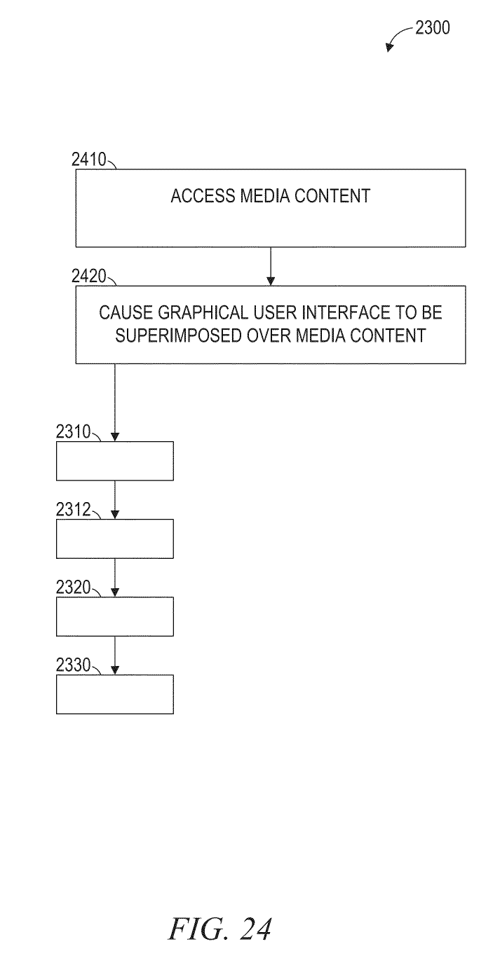

As shown in FIG. 24, the method 2300 may include one or more of operations 2410 and 2420, according to some example embodiments. In operation 2410, the media access module 310 (e.g., within the device 130 or the device 150) accesses the media content 500. For example, the media content 500 may be accessed by receiving it from the server machine 110 (e.g., via the network 190) or any other provider (e.g., third-party provider) of the media content 500. Thereafter, the media presentation module 320 may present the accessed media content 500 on the display 131.

In operation 2420, the user interface module 220 (e.g., within the device 130 or 150) causes the GUI discussed above with respect to FIGS. 5-22 to be superimposed over the media content 500. As a result, the presentation of the first panel 510 and the second panel 520 in operation 2310 may be similarly superimposed over the media content 500, and the presenting of the animated transition in operation 2320 may be similarly superimposed over the media content 500.

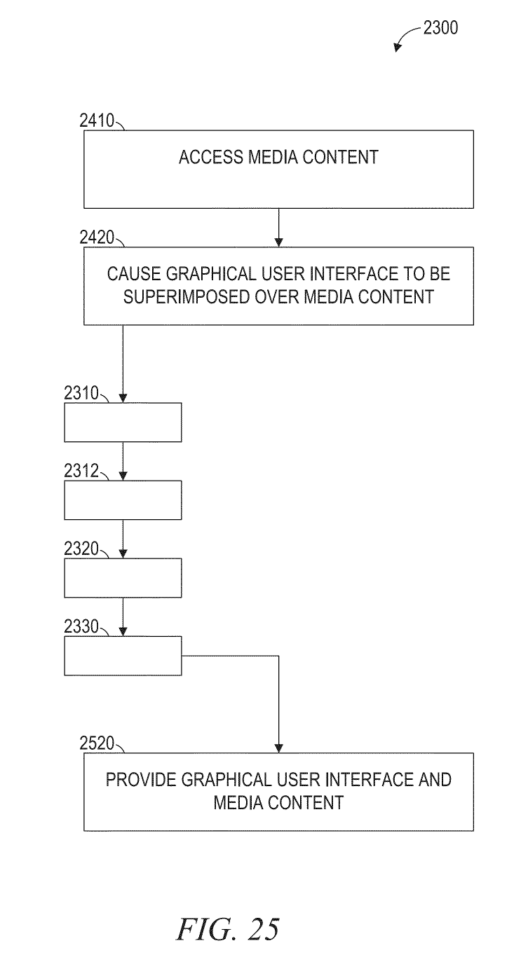

As shown in FIG. 25, the method 2300 may include one or more of operations 2410, 2420, and 2520, according to certain example embodiments. In operation 2410, the server machine 110 accesses the media content 500. For example, the media content 500 may be accessed by receiving it from a third-party provider of the media content 500 (e.g., a third-party media source that is accessible via the network 190).

In operation 2420, the user interface module 220 (e.g., within the server machine 110) causes the GUI discussed above with respect to FIGS. 5-22 to be superimposed over the media content 500. As a result, the presentation of the first panel 510 and the second panel 520 in operation 2310 may be similarly superimposed over the media content 500, and the presenting of the animated transition in operation 2320 may be similarly superimposed over the media content 500.

In operation 2520, the media provision module 210 (e.g., within the server machine 110) provides the media content 500 along with the superimposed GUI to one or more devices (e.g., device 130 or 150) for presentation on the display 131. Accordingly, these devices (e.g., devices 130 and 150) may receive the media content 500 with the GUI discussed above with respect to FIGS. 5-22 already superimposed over the media content 500.

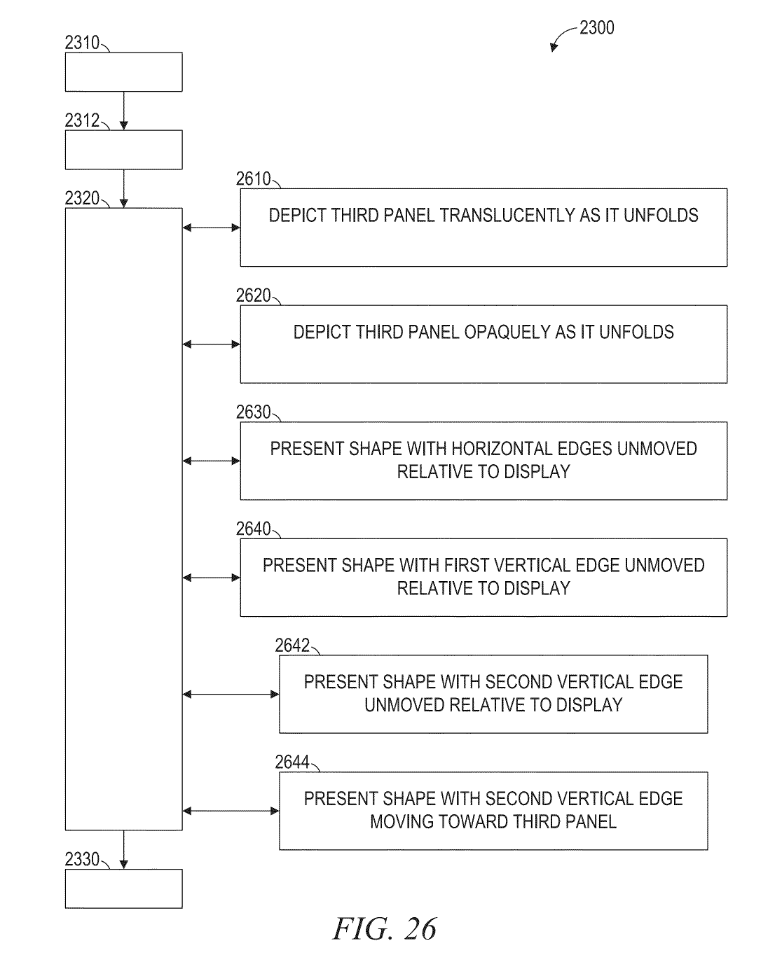

As shown in FIG. 26, the method 2300 may include one or more of operations 2610, 2620, 2630, 2640, 2642, and 2644. One or more of operations 2610, 2620, 2630, 2640, 2642, and 2644 may be performed as part (e.g., a precursor task, a subroutine, or a portion) of operation 2320, in which the user interface module 220 presents the animated transition.

In operation 2610, at least part of the GUI is translucent, and the user interface module 220 depicts the third panel 530 translucently as the third panel 530 unfolds into view. This may have the effect of partially obscuring (e.g., darkening) a portion of the media content 500 (e.g., underneath or behind the third panel 530) as the media content 500 is being presented on the display 131. Other portions of the media content 500 may be completely unobscured during the animated transition.

In operation 2620, at least part of the GUI is opaque, and the user interface module 220 depicts the third panel 530 opaquely as the third panel 530 unfolds into view. This may have the effect of fully obscuring a portion of the media content 500 (e.g., underneath or behind the third panel 530) as the media content 500 is being presented on the display 131. Other portions of the media content 500 may be completely unobscured during the animated transition.

In operation 2630, the user interface module 220 presents the shape 511 with horizontal edges (e.g., top and bottom edges) that remain unmoved relative to the display 131 during the animated transition. For example, the animated transition may be presented with the appearance discussed above with respect to FIGS. 5-10, with the appearance discussed above with respect to FIGS. 11-16, or with any suitable combination thereof.

In operation 2640, the user interface module 220 presents the shape 511 with a first vertical edge (e.g., a right edge) that remains unmoved relative to the display 131 during the animated transition. For example, the animated transition may be presented with the appearance discussed above with respect to FIGS. 5-10, with the appearance discussed above with respect to FIGS. 11-16, with the appearance discussed above with respect to FIGS. 17-22, or with any suitable combination thereof.

In operation 2642, the user interface module 220 presents the shape 511 with a second vertical edge (e.g., a left edge) that remains unmoved relative to the display 131 during the animated transition. For example, the animated transition may be presented with the appearance discussed above with respect to FIGS. 5-10.

In operation 2644, the user interface module 220 presents the shape 511 with a second vertical edge (e.g., the left edge) that moves toward the third panel 530 during at least a portion of the animated transition. For example, the animated transition may be presented with the appearance discussed above with respect to FIGS. 11-16, with the appearance discussed above with respect to FIGS. 17-22, or with any suitable combination thereof.

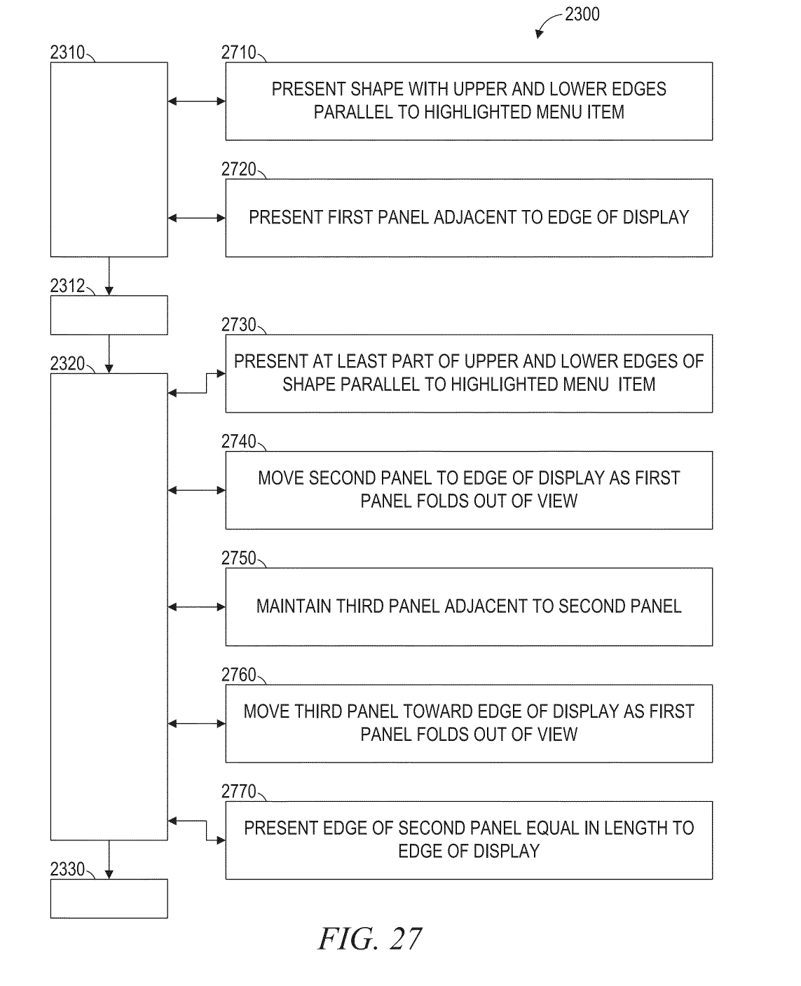

As shown in FIG. 27, the method 2300 may include one or more of operations 2710, 2720, 2730, 2740, 2750, 2760, and 2770. One or more of operations 2710 and 2720 may be performed as part of operation 2310, in which the user interface module 220 presents the first panel 510 and the second panel 520.

In operation 2710, the user interface module 220 presents the shape 511 with upper and lower edges (e.g., top and bottom edges) being parallel to the highlighted menu item at the beginning of the animated transition. For example, the animated transition may be presented with the appearance discussed above with respect to FIGS. 5-10, with the appearance discussed above with respect to FIGS. 11-16, with the appearance discussed above with respect to FIGS. 17-22, or with any suitable combination thereof.

In operation 2720, the user interface module 220 presents the first panel 510 adjacent to an edge (e.g., edge 512) of the display 131. For example, the first panel 510 may be presented adjacent to a left edge of the display 131 (e.g., a left edge of a screen of the display 131), a top edge of the display 131 (e.g., a top edge of the screen of the display 131), a right edge of the display 131 (e.g., a right edge of the screen of the display 131), or a bottom edge of the display 131 (e.g., a bottom edge of the screen of the display 131).

One or more of operations 2730, 2740, 2750, 2760, and 2770 may be performed as part of operation 2320, in which the user interface module 220 presents the animated transition. In operation 2730, the user interface module 220 presents at least part of the upper and lower edges (e.g., the top and bottom edges) of the shape 511 as being parallel to the highlighted menu item as the first panel 510 folds out of view. Since the highlighted menu item may have the appearance of remaining in the same plane as the first panel 510 as it folds, the user interface module 200 may give the upper and lower edges of the shape 511 a similar appearance of remaining in the same plane as the first panel 510 as it folds. For example, the animated transition may be presented with the appearance discussed above with respect to FIGS. 17-22.

In operation 2740, the user interface module 220 moves (e.g., slides) the second panel 520 to an edge (e.g., edge 512) of the display 131 as the first panel 510 folds out of view. For example, as the first panel 510 folds out of view, the second panel 520 may be moved to a left edge of the display 131 (e.g., a left edge of a screen of the display 131), a top edge of the display 131 (e.g., a top edge of the screen of the display 131), a right edge of the display 131 (e.g., a right edge of the screen of the display 131), or a bottom edge of the display 131 (e.g., a bottom edge of the screen of the display 131). This may have the effect of repositioning the second panel 520 to replace the first panel 510 by the end of the animated transition.

In operation 2750, the user interface module 220 shows (e.g., maintains) the third panel 530 adjacent to the second panel 520 as the third panel 530 unfolds into view. For example, the animated transition may be presented with the appearance discussed above with respect to FIGS. 5-10, with the appearance discussed above with respect to FIGS. 11-16, with the appearance discussed above with respect to FIGS. 17-22, or with any suitable combination thereof.

In operation 2760, the user interface module 220 moves (e.g., slides), the third panel 530 toward an edge (e.g., edge 512) of the display 131 as the first panel 510 folds out of view. For example, as the first panel 510 folds out of view, the third panel 530 may be moved toward a left edge of the display 131 (e.g., a left edge of a screen of the display 131), a top edge of the display 131 (e.g., a top edge of the screen of the display 131), a right edge of the display 131 (e.g., a right edge of the screen of the display 131), or a bottom edge of the display 131 (e.g., a bottom edge of the screen of the display 131). This may have the effect of repositioning the third panel 530 to replace the second panel 520 by the end of the animated transition. The combination of operations 2740 and 2760 may have the effect of maintaining the third panel 530 adjacent to the second panel 520 and moving both of them together toward the edge (e.g., edge 512) of the display 131, as the first panel 510 folds out of view. For example, the animated transition may be presented with the appearance discussed above with respect to FIGS. 5-10, with the appearance discussed above with respect to FIGS. 11-16, with the appearance discussed above with respect to FIGS. 17-22, or with any suitable combination thereof.

In operation 2770, the user interface module 220 presents an edge of the second panel 520 equal in length to an edge (e.g., edge 512) of the display 131. For example, the second panel 520 may extend the entire length of a left edge of the display 131 (e.g., a left edge of a screen of the display 131), a top edge of the display 131 (e.g., a top edge of the screen of the display 131), a right edge of the display 131 (e.g., a right edge of the screen of the display 131), or a bottom edge of the display 131 (e.g., a bottom edge of the screen of the display 131). For example, the animated transition may be presented with the appearance discussed above with respect to FIGS. 5-10, with the appearance discussed above with respect to FIGS. 11-16, with the appearance discussed above with respect to FIGS. 17-22, or with any suitable combination thereof.

According to various example embodiments, one or more of the methodologies described herein may facilitate presentation of the GUI with an unfolding panel (e.g., the third panel 530). Moreover, one or more of the methodologies described herein may facilitate presentation of an aesthetically beautiful, elegant, understandable, or otherwise beneficial GUI on a device (e.g., device 130) or to a user thereof (e.g., user 132). Hence, one or more the methodologies described herein may facilitate the user's operation of such a device (e.g., device 130) or the user's interaction with a server machine (e.g., server machine 110).

When these effects are considered in aggregate, one or more of the methodologies described herein may obviate a need for certain efforts or resources that otherwise would be involved in generating and presenting a GUI with an unfolding panel. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 28 is a block diagram illustrating components of a machine 2800, according to some example embodiments, able to read instructions 2824 from a machine-readable medium 2822 (e.g., a machine-readable storage medium, a computer-readable storage medium, or any suitable combination thereof) and perform any one or more of the methodologies discussed herein, in whole or in part. Specifically, FIG. 28 shows the machine 2800 in the example form of a computer system within which the instructions 2824 (e.g., software, a program, an application, an applet, an app, or other executable code) for causing the machine 2800 to perform any one or more of the methodologies discussed herein may be executed, in whole or in part. In alternative embodiments, the machine 2800 operates as a standalone device or may be connected (e.g., networked) to other machines. In a networked deployment, the machine 2800 may operate in the capacity of a server machine or a client machine in a server-client network environment, or as a peer machine in a distributed (e.g., peer-to-peer) network environment. The machine 2800 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 2824, sequentially or otherwise, that specify actions to be taken by that machine. Further, while only a single machine is illustrated, the term “machine” shall also be taken to include any collection of machines that individually or jointly execute the instructions 2824 to perform all or part of any one or more of the methodologies discussed herein.

The machine 2800 includes a processor 2802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 2804, and a static memory 2806, which are configured to communicate with each other via a bus 2808. The processor 2802 may contain microcircuits that are configurable, temporarily or permanently, by some or all of the instructions 2824 such that the processor 2802 is configurable to perform any one or more of the methodologies described herein, in whole or in part. For example, a set of one or more microcircuits of the processor 2802 may be configurable to execute one or more modules (e.g., software modules) described herein.

The machine 2800 may further include a graphics display 2810 (e.g., a plasma display panel (PDP), a light emitting diode (LED) display, a liquid crystal display (LCD), a projector, a cathode ray tube (CRT), or any other display capable of displaying graphics or video). The machine 2800 may also include an alphanumeric input device 2812 (e.g., a keyboard or keypad), a cursor control device 2814 (e.g., a mouse, a touchpad, a trackball, a joystick, a motion sensor, an eye tracking device, or other pointing instrument), a storage unit 2816, an audio generation device 2818 (e.g., a sound card, an amplifier, a speaker, a headphone jack, or any suitable combination thereof), and a network interface device 2820.

The storage unit 2816 includes the machine-readable medium 2822 (e.g., a tangible and non-transitory machine-readable storage medium) on which are stored the instructions 2824 embodying any one or more of the methodologies or functions described herein. The instructions 2824 may also reside, completely or at least partially, within the main memory 2804, within the processor 2802 (e.g., within the processor's cache memory), or both, before or during execution thereof by the machine 2800. Accordingly, the main memory 2804 and the processor 2802 may be considered machine-readable media (e.g., tangible and non-transitory machine-readable media). The instructions 2824 may be transmitted or received over the network 190 via the network interface device 2820. For example, the network interface device 2820 may communicate the instructions 2824 using any one or more transfer protocols (e.g., hypertext transfer protocol (HTTP)).

In some example embodiments, the machine 2800 may be a portable computing device, such as a smart phone or tablet computer, and have one or more additional input components 2830 (e.g., sensors or gauges). Examples of such input components 2830 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 2822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 2824 for execution by the machine 2800, such that the instructions 2824, when executed by one or more processors of the machine 2800 (e.g., processor 2802), cause the machine 2800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
presenting first and second panels of a graphical user interface on a display,
the first panel showing a set of menu items that include a menu item highlighted by a shape that surrounds the menu item;
the second panel being adjacent to the first panel and showing a set of sub-menu items that correspond to the highlighted menu item in the first panel;
using a processor of a machine and in response to selection of the highlighted menu item in the first panel, presenting a simulated transition in which:
the first panel appears to fold out of view behind the second panel,
a third panel of the graphical user interface appears to unfold into view from behind the second panel, and
the shape transitions from surrounding the menu item in the first panel to surrounding a sub-menu item among the set of sub-menu items in the second panel; and
presenting the second and third panels on the display after the simulated transition, the second panel showing the sub-menu item highlighted by the shape.

2. The method of claim 1, wherein:
the third panel is adjacent to the second panel and shows a set of sub-sub-menu items that correspond to the sub-menu item highlighted in the second panel.

3. The method of claim 1 further comprising:
causing the graphical user interface to be superimposed over media content; and wherein
the presenting of the simulated transition presents the simulated transition superimposed over the media content.

4. The method of claim 3, wherein:
the graphical user interface is translucent; and
the simulated transition depicts the third panel translucently as the third panel appears to unfold into view and darken a portion of the media content.

5. The method of claim 3, wherein:
the graphical user interface is opaque; and
the simulated transition depicts the third panel opaquely as the third panel appears to unfold into view and obscure a portion of the media content.

6. The method of claim 3, wherein:
a portion of the media content remains unobscured throughout the simulated transition in which the third panel appears to unfold into view.

7. The method of claim 1, wherein:
the presenting of the simulated transition presents the shape with horizontal edges that remain unmoved relative to the display during the simulated transition.

8. The method of claim 1, wherein:
the presenting of the simulated transition presents the shape with a first vertical edge that remains unmoved relative to the display during the simulated transition.

9. The method of claim 8, wherein:
the presenting of the simulated transition presents the shape with a second vertical edge that remains unmoved relative to the display during the simulated transition.

10. The method of claim 8, wherein:
the presenting of the simulated transition presents the shape with a second vertical edge that moves toward the third panel during at least a portion of the simulated transition.

11. The method of claim 1, wherein:
the presenting of the first and second panels presents the shape with upper and lower edges parallel to the highlighted menu item in the first panel at the beginning of the simulated transition.

12. The method of claim 11, wherein:
the presenting of the simulated transition presents at least part of the upper and lower edges of the shape parallel to the highlighted menu item as the first panel appears to fold out of view.

13. The method of claim 1, wherein:
the presenting of the first and second panels presents the first panel adjacent to an edge of the display.

14. The method of claim 13, wherein:
the presenting of the simulated transition moves the second panel to the edge of the display as the first panel appears to fold out of view.

15. The method of claim 13, wherein:
the presenting of the simulated transition maintains the third panel adjacent to the second panel and moves the second and third panels together toward the edge of the display as the first panel appears to fold out of view.

16. The method of claim 13, wherein:
the presenting of the simulated transition presents an edge of the second panel equal in length to the edge of the display.

17. The method of claim 1, wherein:
the first panel of the graphical user interface includes a first polygonal graphical object presented on the display; and
the second panel of the graphical user interface includes a second polygonal graphical object presented on the display.

18. A non-transitory machine-readable storage medium comprising instructions that, when executed by one or more processors of a machine, cause the machine to perform operations comprising:
presenting first and second panels of a graphical user interface on a display,
the first panel showing a set of menu items that include a menu item highlighted by a shape that surrounds the menu item;
the second panel being adjacent to the first panel and showing a set of sub-menu items that correspond to the highlighted menu item in the first panel;
in response to selection of the highlighted menu item in the first panel,
presenting a simulated transition in which:
the first panel appears to fold out of view behind the second panel,
a third panel of the graphical user interface appears to unfold into view from behind the second panel, and
the shape transitions from surrounding the menu item in the first panel to surrounding a sub-menu item among the set of sub-menu items in the second panel; and
presenting the second and third panels on the display after the simulated transition, the second panel showing the sub-menu item highlighted by the shape.

19. The non-transitory machine-readable storage medium of claim 18, wherein:
the presenting of the first and second panels presents the first panel adjacent to an edge of the display; and
the presenting of the simulated transition presents the shape with a first vertical edge that is nonadjacent to the edge of the display and remains unmoved relative to the display during the simulated transition.

20. A system comprising:
one or more processors; and
a user interface module that configures the one or more processors to:
present first and second panels of a graphical user interface on a display,
the first panel showing a set of menu items that include a menu item highlighted by a shape that surrounds the menu item;
the second panel being adjacent to the first panel and showing a set of sub-menu items that correspond to the highlighted menu item in the first panel;
in response to selection of the highlighted menu item in the first panel,
present a simulated transition in which:
the first panel appears to fold out of view behind the second panel,
a third panel of the graphical user interface appears to unfold into view from behind the second panel, and
the shape transitions from surrounding the menu item in the first panel to surrounding a sub-menu item among the set of sub-menu items in the second panel; and
present the second and third panels on the display after the simulated transition, the second panel showing the sub-menu item highlighted by the shape.

21. The system of claim 20 further comprising:
a media presentation module that configures the one or more processors to present media content on the display; and wherein
the user interface module configures the one or more processors to cause the graphical user interface to be superimposed over the media content presented on the display.

22. The system of claim 20 further comprising:
a media provision module that configures the one or more processors to provide media content to a device for presentation on the display; and wherein
the user interface module configures the one or more processors to cause the graphical user interface to be superimposed over the media content provided to the device.
